(19) United States
(12) Patent Application Publication
(10) Pub. No.: US 2014/0067650 A1
(43) Pub. Date: Mar. 6, 2014

(54) METHODS AND SYSTEMS FOR CONSUMER LENDING

(71) Applicant: Clearmatch Holdings (Singapore) PTE. LTD., Singapore (SG)

(72) Inventors: Philip Gardiner, Sydney (AU); Greg Symons, Sydney (AU); Matt Symons, Sydney (AU)

(73) Assignee: CLEARMATCH HOLDINGS (SINGAPORE) PTE. LTD., SINGAPORE (SG)

(21) Appl. No.: 14/011,313

(22) Filed: Aug. 27, 2013

Related U.S. Application Data
(60) Provisional application No. 61/694,186, filed on Aug. 28, 2012.
(60) Provisional application No. 61/717,958, filed on Oct. 24, 2012.

(51) Int. Cl. G06Q 40/02

(52) U.S. Cl. CPC G06Q 40/025
USPC 705/38

(57) ABSTRACT

Systems and methods for lending based on automatic retrieval from third-party databases of data for loan qualification scoring factors in the nature of: financial management, leadership, social networking, advocacy, and accountability, and providing investors a borrower credit profile and/or loan qualification score derived at least in part from the scoring factors. A method of dynamic loan pricing, including the steps of: periodically updating an existing borrower's credit profile, and changing the terms of an existing borrower's loan, or making a new loan offering, based on an updating. A method of lending based on automated use of the following loan qualification scoring factors: financial management, leadership, social networking, advocacy, and accountability. Methods and systems for creating fractional units of a loan and offering the units to lenders to create a loan that is the aggregate of multiple subloans (loan subunits) from different lenders.

### RELATED APPLICATIONS

This application claims priority to and the benefit of U.S. provisional patent application Nos. 61/694,186, filed on Aug. 28, 2012, entitled METHOD AND SYSTEM FOR AUTOMATED PROCESSING OF DATA and 61/717,958 filed on Oct. 24, 2012, entitled METHODS AND SYSTEMS FOR CONSUMER LENDING, the contents of which is hereby incorporated by reference as if recited in full herein for all purposes.

### BACKGROUND

The inventive subject matter disclosed herein relates to lending marketplace for consumer loans, particularly, both secured and unsecured loans, including personal loans and lines of credit and real estate loans.

A lending marketplace consists of borrowers seeking loans and investors who agree to provide the loan funds in return for a commitment from the borrower to repay the funds on agreed terms. Traditionally loans for consumers have been offered/funded by a bank as the investor, but increasingly marketplaces are evolving that provide greater access for a wider range of participants to act as investors.

The pricing of loans is a function of traditional supply and demand, but with the added dimension of risk profiles. Demand represents the number of borrowers of a particular risk profile, and the supply represents the amount of investment funding available for borrowers of that risk profile. An added nuance is that on the supply side, risk is ultimately perceived rather than actual, with investor perceptions based on any number of factors. Among the most dominant risk factor is the borrower's credit risk score, but risk factors possibly include socioeconomic factors (e.g., borrower's location, job category, education, etc.) and behavioral factors (e.g., borrower's job tenure, time to complete tertiary education, job promotion rate, etc.)

Borrowers can be profiled by a combination of one or more of their credit risk score; socioeconomic and behavioral factors; their need for credit (including urgency); and price sensitivity. Conventionally, borrower credit scores are calculated as of a point in time based on borrower behaviors to date.

Investors (also referred to herein as “lenders”), e.g., lending institutions or private investors, can be described by their risk-appetite, as measured by their willingness to invest in specific borrower credit profiles, as well as other factors, such as their return expectations, investment objectives, requirement for investment diversity, and behavior profile (e.g., high level of activity versus low level of activity, or sophisticated investment criteria versus general criteria).

The financial services industry uses a variety of online forms to elicit personal online loan applications from consumers over the Internet. These personal loan applications are assessed by the institution to which the consumer applied. And if, after verifying the information provided in the loan application, the loan applicant meets the financial institution's minimum-viable credit criteria, the loan application may be approved, and an offer of credit is extended to the loan applicant. In the personal loans market, this offer of credit is generally made at a fixed rate for a defined term (e.g., 15% interest rate on the loan with a 3-year duration) or is a variable rate loan (e.g., set in accordance to interest rates) for a fixed duration.

These loan applications take various forms, such as HTML web-based forms or printed loan applications. In all cases, they require the loan applicant to submit data and then verify that data via the provision of credible third-party source data such as driver's license, social security number, or bank statements. The credit assessment undertaken by financial institutions is a point in time analysis of the creditworthiness of the applicant for the purpose of determining whether an offer of credit will be extended to the applicant, and, if so, on what terms. Once an offer of credit has been extended, and if it is accepted, the resulting loan may be locked-in for a fixed term, at a fixed interest rate, and/or for a fixed term but with a variable rate. Variable rates may fluctuate according to a pre—defined relationship with the swap rate or the cash rate (i.e., measures of underlying interest rates).

Unfortunately, one substantial disadvantage for the foregoing prior art lending systems is that borrowers cannot enhance their attractiveness to the lending institution during the course of the loan. Equally disadvantageous, the prior art systems do not allow lending institutions flexibility to reassess borrower risk based on non-traditional factors, namely factors that are other than those traditionally used in scoring by credit bureaus.

FIG. 1 shows a diagram outlining the traditional, “as is”, loan application process. It may be summarized as follows:

| Key Process | |
|---|---|
| Steps | Description |
| [101] A | In traditional methods of credit scoring, the calculation of |
| customer | the score relies heavily on a fixed set of data values (typi- |
| (borrower) | cally around 45 questions) taken from the application |
| completes a | form that are evaluated for their correlation to the |
| loan applica- | dependent variable (e.g., loan default). The data values |
| tion form (on- | can be described as ‘point in time’ values (e.g., the value |
| line or hard- | of an applicant's assets at a certain date). |
| copy) | |
| [102] 3^{rd} party | Searches against central credit bureau data to retrieve the |
| data is | customer's credit history records and to perform checks, |
| retrieved | such as anti-money laundering. |
| [103] Loan | The calculation of the applicant's loan qualification score |
| qualification | is generally done via a regression model where the input |
| score | values are given weights corresponding to their corre- |
| Calculation | lation to a default event, and the overall loan qualifica- |
| | tion score is the sum of the weighted scores. The as- |
| | sessment of the loan affordability is based on the |
| | applicant's uncommitted monthly income, or on the |
| | money they have left each month after expenses are |
| | removed from their income. |
| [104] Pricing | Effectively a table that lists prices by Application |
| Policy | scores |
| [105] Lending | The application is ultimately approved or declined. If |
| Offer | approved the customer will be made an offer of a loan |
| | amount and rate. The customer then has the option at |
| | [106] to accept the offer and proceed to funding, or |
| | reject it. |

A characteristic of a lending marketplace, relative to loans offered by entities, such as banks, is the number and variety of individual lenders who fund loans. As a consequence, the traditional black-box approach to credit scoring, as described above, does not cater well to the needs of a marketplace made up of many lenders. In other words, the industry's heavy reliance on a credit score provides little basis on which lenders can granularly discriminate between various borrowers.

In a lending marketplace, the credit scoring process serves the purposes of enabling a minimum standard of borrower credit worthiness to be set, and the basis on which a group of lenders assess potential borrowers relative to their own investment criteria.

Limitation/Issues of the ‘As is’ process

| | |
|---|---|
| Example | As an example of the limitation of this approach, highly |
| | predictive inputs in a traditional credit scoring process |
| | are, firstly, whether a borrower has had a previous default, |
| | and secondly, the age of their credit file, which together |
| | may indicate for an older applicant without any previous de- |
| | faults, a sustained, good credit history and hence, a low |
| | probability of future default. By contrast, a younger appli- |
| | cant without a previous default is likely to be scored as |
| | having a higher probability of future default simply because |
| | of the young age of their credit file. Due to a lack of other |
| | predictive inputs utilized within the traditional credit scor- |
| | ing process, the younger applicant must effectively wait (typi- |
| | cally a number of years) for their score to improve. |

Another disadvantageous feature of traditional lending marketplace is that there is one investor funding a given borrower's loan. Because of this, fewer loans may be funded. Traditional lending marketplace, do not have a system under which many investors participate in funding each loan, as a means of both spreading risk and allowing greater lender participation.

Finally, because traditional lending systems lack of granularity in assessing borrowers, they do not achieve a balanced mix of compatible lenders and borrowers. A biased marketplace results in one side being disadvantaged and high operating costs due to inefficiencies.

In view of the foregoing limitations and disadvantages in traditional lending systems, new approaches to assessing credit scoring and loan approvability are needed to benefit both borrowers and lending institutions. There is also a need for systems that allow multiple borrowers to participate in the funding of a given loan. There is also a need for the intelligent use of data to direct and co-ordinate marketing activities designed to keep a balanced flow of lenders and borrowers into the marketplace.

The foregoing is not intended to be an exhaustive listing of disadvantages and needs in traditional lending systems. Other disadvantages and needs exist which are addressed by the inventive subject matter disclosed herein.

### SUMMARY

In very general terms, the inventive subject matter consists of various related lines of invention that are directed to optimization of lending marketplaces. Optimization may occur at at least two levels: firstly a number of inventions designed to improve functions within a lending marketplace, and secondly inventions designed to further improve the overall operation of a lending marketplace by integration of intelligence and inter-working between functions. The following is a description of various inventive lines under the inventive subject matter. The appended claims, as originally filed in this document, or as subsequently amended, are hereby incorporated into this Summary section as if written directly in.

### Automated Loan Qualification Profiling

In certain respects, the inventive subject matter is generally directed towards enabling consumers to apply for loans without the need to complete elaborate forms, as used in traditional lending marketplaces. Instead of the traditional loan application process whereby a potential borrower enters personal information into a form that a financial institution then assesses for creditworthiness, in the inventive subject matter, the potential borrower may simply provide consent for their personal information to be extracted, preferably automatically via computer instructions and systems, from relevant third party databases and processed for the purpose of qualifying the borrower for one or more lending offers from lending institutions or other investors. In other words, the inventive subject matter enables borrowers to be automatically profiled for lending offers and qualified without the needs for tedious, traditional loan applications. In certain embodiments disclosed herein, qualification may be based on non-traditional assessment factors, as discussed below.

### Loan Qualification Scoring (“Scorecards”)

In some embodiments, the inventive subject matter is directed to innovative methods of assessing a borrower's qualifications for a lending offer to be provided by one or more investors. A set of loan qualification assessment factors may be referred to as a “scorecard” herein. Loan scorecard may be used to determine a loan qualification score.

In addition to, or instead of, traditional data sources, such as credit bureau scores, current bank statements and assets values, the inventive subject matter may assess borrower qualifications based a wide range of other assessment factors. For example, social network sites such as Facebook, LinkedIn, Twitter, etc. offer multiple forms of data such as number of network connections, frequency of activity, nature of content, reactions to third party content, biographical information, etc. According to the inventive subject matter, a computer system may be configured with one or more application programming interfaces (APIs) for communicating with third-party social network sites. As a method steps according to the inventive subject matter, the computer system may retrieve data from such sites and use the data to generate a profile for borrower or borrower qualification rating for a loan (see discussion of borrower scorecards below).

The inventive subject may also make use of temporally longitudinal data rather than point in time snapshots. For example, rather than using an applicant's current income as an input in a credit score calculation, the inventive methods may use the applicant's income over a period of time to create new attributes such as income stability, rate of growth of income, etc.

Along similar lines social network data may be analyzed to create attributes measuring behavioral competencies in areas such as networking, gaining advocacy and leadership to create a multi-dimensional profile of the borrower. The overall loan qualification score may be a composition of a number of weighted or un-weighted assessment factors, each with their own scoring processes and algorithms. As an example, a traditional credit bureau score may be one factor within a composite scorecard; an overall rating of behavioral competencies displayed by a consumer, as discussed in more detail below, may be another. One benefit of this aspect of the inventive subject matter is that the resulting scorecard will be significantly more accurate and predictive than traditional scores, particularly among some segments of the market.

### Predictive Scores to Support Dynamic Pricing

In still other respects, the inventive subject matter is generally directed towards enabling borrowers and investors/lenders to enter into forward-looking, mutually-beneficial, incentive based loan arrangements. As a method step, a loan qualification score is calculated for a potential borrower at the time of application for the purpose of assessment. The score may be dynamic over a period of time, as more relevant behavioral data about the borrower become apparent. Specifically, for many borrowers: (1) their loan qualification score increases as they demonstrate good credit behavior in relation to credit products; and (2) their creditworthiness increases over time as they achieve higher levels of employment, income and levels of financial literacy. Accordingly, the inventive subject matter provides computer systems and methods for assessing both the current and future credit risk of the borrower, and may use the assessments as additional factors in setting loan pricing dynamically over the term of the loan or at set points in the loan term. A benefit of this approach is that investors are given the opportunity to identify and invest in borrowers based partly on their likely future creditworthiness. In doing so they are able to trade-off short-term returns against longer-term returns. Borrowers also benefit by way of early recognition of their future value in the market.

### Investors Able to Create Custom Scorecards

A characteristic of a lending marketplace is that there are many lenders providing credit to borrowers, and that each lender may have their own personal biases when evaluating investment opportunities. Although existing lending marketplaces offer lenders the ability to view and filter loan applications by a number of parameters, such as credit score, income, debt to income ratio, etc., in certain embodiments according to the inventive subject matter, a lender via a computer system, may customize their own scorecard system or template so that they have a far greater degree of flexibility in applying their own bias when evaluating the credit worthiness of borrowers. For example, a lender, over a computer system configured with customization program, may set their own weightings on factors within the scorecard to place more emphasis on behavioral competencies rather than on a credit bureau score. They may also be able to weigh specific behaviors they believe to be important. Lenders who have created their own custom scorecard may see borrowers scored by one or both of a standardized scorecard and their own, customized scorecard. As a result, the marketplace will support a far greater degree of diversity in the assessment of risk among lenders, and hence enable a greater diversity of credit-funding opportunities.

In further respects the inventive subject matter is directed to a computer system with a set of executable instructions for communicating with a plurality of third-party databases, each such database storing data relevant to a specified potential borrower's or specified existing borrower's qualification for a loan, e.g., the borrower's approvability or worthiness for a loan. Similarly, the data may be relevant a potential or existing borrower's qualification for changing terms of an existing loan. The set of instructions may provide for retrieving the relevant data from a plurality of the third party databases; automatically processing the data into a loan application and/or a loan qualification rating for a loan; and providing or otherwise making accessible via a computer network the loan application or qualification rating to an investor or lender. In certain embodiments, the system and/or instructions may be customized to the needs of particular lenders or investors.

### Dynamic Pricing

In some embodiments, the inventive subject matter is directed to a method of dynamic loan pricing performed over a computer system that includes computer executable instructions for the method steps of: periodically updating an existing borrower's qualification for a loan, e.g., the approvability or worthiness of the borrower for the loan, and changing the terms of an existing borrower's loan during the term of the loan, or making a new loan offering based on an update, wherein the change in terms includes a change in interest rate, loan term, loan amount, and/or monthly payment.

### Investor Profiling, Demand Modeling & Pricing

In some embodiments, the inventive subject matter is directed to enabling efficiency within the marketplace by allowing borrowers and lenders to make trade-off decisions between (1) the terms of lending and (2) the time taken to achieve full loan funding. An issue of existing lending marketplaces is that discrepancies in price expectations between borrowers and investors leads to large numbers of loan applications remaining only partly funded after an auction process, which are eventually cancelled by the system. For borrowers, this means they are unable to obtain the funds they are seeking. For lenders, it means they have funds allocated against loan applications (not earning a return) that ultimately do not become loans.

In some embodiments according to the inventive subject matter, a computer system may be configured analyze a large number of factors to determine the level of demand for each loan application across a range of loan terms and translate this demand into an estimate of the likely time to achieve full funding from lenders. As an example, a borrower who has immediate need for funding may choose to accept a higher interest rate than an equivalent borrower without an immediate need. Similarly, investors seeking to have funds fully invested may choose to accept a slightly lower return. A benefit of this flexible approach is that both borrowers and lenders are provided with appropriate knowledge to enable sensible trade-off decisions to be made between loans terms and funding time.

### Loan Slicing and Auction

Some embodiments of the inventive subject matter contemplate a marketplace where multiple investors may participate in funding a given loan. For example, loans may be split in fractional units and then offered to lenders. For example, the offering could be via an auction process carried out over computer network that is in communication with computer systems of auction participants. The splitting function can be performed in any number of manners. For example, each loan may be split unto 100 units. The units are offered to lenders at the same loan interest rate. In other embodiments, a loan may be composed of units priced at different rates, as dictated, for example, by lender competition. Hence the actual rates paid by borrowers are a blended rate. In still other embodiments, the lending system may include computer systems that are configured with intelligent rules for splitting loans and auctioning them to lenders depending on factors, such as the supply and demand for a particular class of loan, and the risk profile of the loan.

In some embodiments, the inventive subject matter is directed to methods and processes of auctioning or otherwise offering borrower loans to investors, comprising: splitting a borrower's loan application request into fractional units to be offered to lenders. By “fractional unit” it is meant that the loan is broken down into multiple, smaller parts. A plurality of lenders would effectively fund loans by purchasing such units. Borrowers may nominate the lending rate they are willing to accept (typically a maximum rate), and individual investors can offer funding up to a maximum value (i.e., the maximum number of units) at any rate they choose. A computer system will attempt to automatically create a deal by collating investor bids or offers in such a way as to derive an acceptable blended rate. A successful investor/lender bid is then transformed in the computer system into a sub-loan with its own amount (i.e., number of units) and pricing. Therefore, there are many sub-loans created to fund a single borrower's loan, which aggregate in value and with a blended rate for the borrower's loan. Hence in a marketplace with many investors and many borrowers, under the inventive subject matter, there are potentially many ways to collate deals, so there is an optimization opportunity around how to best create utility for borrowers, lenders, and the marketplace operator.

The splitting process and system may include computer executable instructions representing rules sets that control related lending parameters. For example, the lending system may be configured with rules that control the maximum investment any single lender can make in a loan. As another example, a rule set may control the collecting lender funding bids—the auction process whereby borrowers and lenders agree on funding terms and whereby the blended rate of the borrower's loan is determined. As another example, a rule set may control the allocating units of sub-loans to investors that aggregate to the borrower's total loan amount, both in value and loan terms. Within these processes and related rule sets, the system may dynamically vary the execution, including for example, the configuration of loan units and the auction method or other offering performed to enable optimization of the marketplace. For instance, consider two applications for loans of similar amounts but with different risk profiles. The higher risk application may be broken into smaller units to reduce the potential loss for any single lender. In doing so, the marketplace is able to customize the auction or offering process to the specifics of each auction or offering and the nature of supply and demand that exists at the time.

In other embodiments, the inventive subject matter is directed to a method of lending executed over a computer system. As a step in the method, the computer system stores a plurality of existing borrower or potential borrower credit profiles, each borrower credit profile comprising at least (i) a desired loan amount or other loan term and (ii) a scorecard relevant to a specified potential borrower's qualification for a loan, or specified existing borrower's, approvability or worthiness or other qualification for a loan or a qualification for changing terms of an existing loan. In the method, each scorecard may be based, at least in part, on third-party data that is relevant to three or more of the following loan qualification assessment factors: financial management, leadership, social networking, advocacy, and accountability. As a step in the method, one or more of the borrower profiles are communicated over a computer network to investor or other lender computer systems. As a step in the method, the central computer system receives, in response to the provision of borrower credit profiles, a loan funding offer responsive to one or more of the borrower profiles.

The various inventive lines reflected in the embodiments described above provide significant advancement and benefits for the operation of a lending marketplace. However, the inventive subject matter further contemplates an additional set of inventive lines directed towards methods of creating higher levels of utility for marketplace participants. This utility may be created by the coordination of processes and functions that exist within the system based on intelligence derived about factors such as: (1) the current and future volumes of supply and demand for credit that exist; and (2) the of level of compatibility between the borrower credit profiles and investor profiles both in isolation and in aggregate. In such a system, the coordination of processes and functions is designed to maximize the volume of loans able to be funded within the marketplace (including agreeable rates, degree of diversity required by lenders); the time taken to achieve funding; and appropriate distribution of risk among lenders in the marketplace.

In some embodiments, the system may be configured with two controlling modules that optimize the overall operation of the marketplace: (1) a loan-slicing module that decides how to best slice up and auction loans that are approved by the system for funding; and (2) a borrower/lender marketing module that coordinates and matches the supply and demand of credit into and within the marketplace.

### Optimal Loan Slicing

In other embodiments, the inventive subject matter is directed towards methods of analyzing selected information known to the system for the purpose of calculating the optimal slicing configuration of requested or stated amounts in loan applications into smaller loan units to be created and offered to lenders. An offering may include determining a method of auctioning loan units. The potential demand for each loan application in a pool of applications may be determined by analyzing factors such as (but not limited to): the credit profile of the borrower requesting a loan; the loan terms sought by the borrower, the universe of borrowers with similar credit profiles, both currently on the system and likely to enter the system; and the investment preferences of investors, both stated and derived through analysis. An optimization algorithm can then be performed on each loan application to determine how it should be best split into smaller units and offered to investors to optimize the overall flow of lending through the marketplace and benefits to all participants. A possible example of an algorithm for optimal loan slicing might be as follows: (1) the system continuously defines a rank-order of investor interest and funding capacity for each loan on the platform by looking across all investors to identify those with allocation capacity (i.e.; a credit grade) and then ordering them according to time elapsed since most recent filled loan from greatest to least; (2) take the prioritized list from the above step and identify the highest ranked 200 investors; (3) the system then looks for the existence of a similar loan to the one being considered for “loan slicing”, either currently in the marketplace or if forecast by the marketing team/module; and (4) if no similar loan is present or expected then slice the loan so that it is allocated to the top 200 investors; alternatively, if another similar loan is present or expected, then allocate the first loan to the first 100 investors and the next loan to the second group of 100 investors. As an example, requested or stated amounts in loan applications of borrowers whose profiles are in the highest demand from investors may be split into greater numbers to maximize the number of investors able to provide funding (while still being able to be funded in a reasonable time frame at acceptable terms), whereas loan applications of borrowers with profiles sought after by relatively few investors would be split into few units (as determined by the risk profile of the borrower) so that fewer investors would be required to achieve funding.

Intelligence Driven Marketing to Coordinate Supply and Demand within the System

In other embodiments, the inventive subject matter is directed towards computer systems configured with computer executable instructions representing or related to method steps of enabling marketing to borrowers and investors of specific borrower credit profiles or lending programs (which programs may be part of an “investor (lender) profile”). The systems and methods help to coordinate the supply and demand for credit within the marketplace. As a method step, there may be periodic or continuous analyzing of over and under supply of borrower and investor (lender) profiles within the marketplace; multi-channel marketing optimization algorithms; and a digital marketing platform. An example might be an algorithm that calculates the probabilistic likelihood that a particular loan profile will be attracted to the marketplace within a defined period of time given set of marketing activities and spending—e.g., the likelihood that a campaign conducted through a specific channel (such as a display network, email campaign, Google Adword campaign, etc.) to a target audience (e.g., cookie-based targeting, customer lists, search terms, etc.) with a specific offer (e.g., display ad, headline message, benefit messages, etc.) will attract a specific profile of borrower. The inventive subject matter enables operators of the marketplace to run periodic or continuous marketing campaigns directed at acquisition or upsell of borrowers and investors in concert with the dynamic nature of the marketplace. For example, as a method step, the system may detect an oversupply of investors with specific investment criteria. As another method step, the detection may cause the generating of a campaign to acquire more borrowers who fit the required profile. As another method step, the specific details of the campaign execution would be based on ongoing analysis of the marketing tactics correlating to the previous acquisition of borrowers who meet the investment profiles. The execution of marketing campaigns to attract borrowers and lenders into the marketplace may be managed by the marketplace operators, and may include the option to conduct pooled marketing campaigns on behalf of marketplace participants.

These and other embodiments are disclosed in more detail herein.

### BRIEF DESCRIPTION OF THE DRAWINGS

Except as indicated, the Figures accompanying this specification show representative embodiments according to various lines of inventive subject matter.

FIG. 1 is a flow diagram describing a traditional, prior-art loan application process.

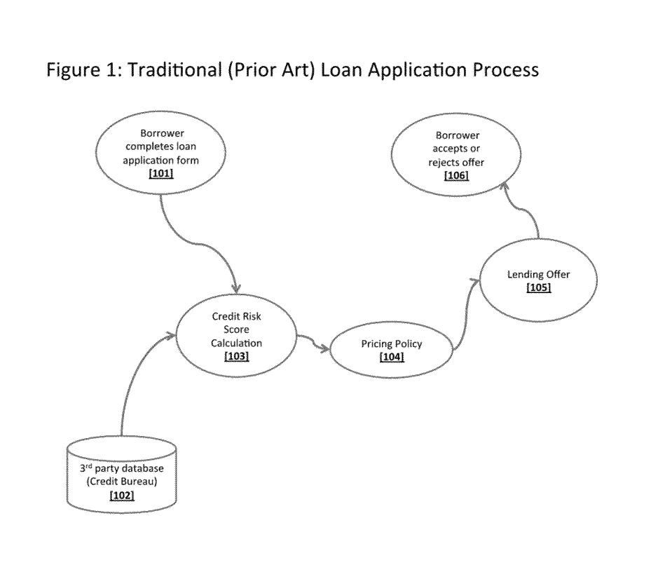

FIG. 2 is a flow diagram illustrating an exemplary method of creating a borrower registration, a borrower loan application, an investor registration process and investors funding the loan application within a lending marketplace.

FIG. 3 illustrates a screen shot of a lending offer made to a loan applicant highlighting the applicant's choice to trade-off between achieving the lowest interest rate against time to obtain funds.

FIG. 4 is a flow diagram illustrating an exemplary method of dynamic pricing of loans based on the ongoing behaviors of a borrower within a peer-to-peer lending marketplace.

FIG. 5 is a screen shot of a GUI showing a rate schedule, loan conditions and penalties for a dynamic pricing offer.

FIG. 6 is a block diagram illustrating the system components of investor supply, borrower demand, and matching and pricing as inputs into loan slicing

FIG. 7 is a block diagram of a peer-to-peer lending system.

FIG. 8 is a block diagram illustrating components associated with a peer-to-peer lending system.

FIG. 9 is a flowchart illustrating a method a registering an investor.

FIG. 10 is a flowchart illustrating a method of registering a borrower.

FIG. 11 is a flowchart illustrating a method of authenticating an applicant's banking and social networking accounts with their customer profile during the registration process.

FIG. 12 is a flowchart illustrating a method of a borrower requesting a loan.

FIG. 13 is a flowchart illustrating the creation of a loan qualification score for a borrower.

FIG. 14 is a flowchart illustrating a method of a borrower's loan qualification score being updated.

FIG. 15 is a flowchart illustrating a method of an investor setting up a customer loan scorecard on a peer to peer lending system.

FIG. 16 is a flowchart illustrating a method a borrower setting the maximum loan pricing they are prepared to accept.

FIG. 17 is a flowchart illustrating a method of posting a borrower's loan application on the system for funding.

FIG. 18 is a flowchart illustrating a method of investors setting automatic funding instructions.

FIG. 19 is a screen shot depicting a borrower's option to request a loan with dynamic pricing.

FIG. 20 is a description of the process of developing behavior based competency scores that are predictive of creditworthiness.

FIG. 21 is an exemplary diagram of a computing environment in which systems and methods consistent with the principles of the invention may be implemented.

### DETAILED DESCRIPTION

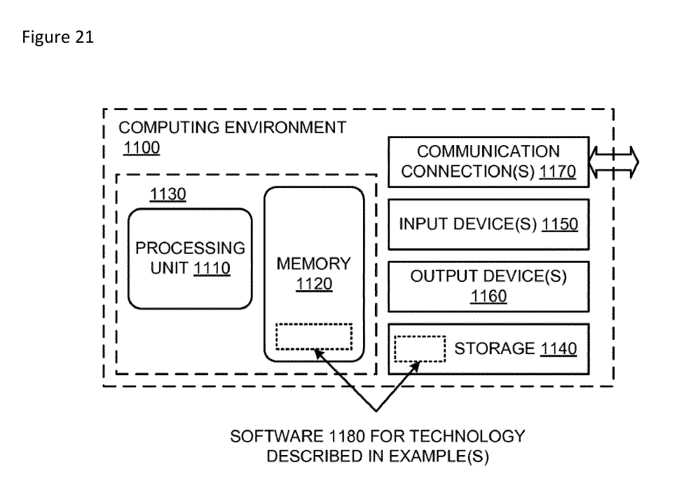

As described in more detail below, in connection with FIG. 21, the inventive systems and methods contemplated herein may be implemented on or executed over known general or special purpose computing systems. In general, such computer systems would include one or more processors, and memory for storing computer executable instructions and data representing or related to method steps disclosed herein. The systems may also include databases, optical drives, memory card readers, network interface devices for communication with remote systems or devices over a data and telecommunications networks, display screens, physical user interfaces, such as keyboards, mice, touchscreens, touchpads, speakers, printers, and cameras, and a set of stored instructions configured for executing one or more of the inventive concepts disclosed herein. Computers in the system may communicate with each other over the Internet, LANs, WANs, or other known or future data and telecommunications networks. The methods described herein may be stored as executable instructions, e.g., software, on any known or future media for electronic storing data of data, including hard drives, solid state memory modules, removable memory cards, and optical discs. The instructions may include instructions for executing any of the steps contemplated herein, including algorithms and other logical processes; and instructions for generating graphical user interfaces for inputting data or presenting the data and information generated in accordance with the steps described herein.

It will be apparent to any one skilled in the art that the various embodiments disclosed herein relate to computer systems wherein data associated with each method contemplated is processed and stored and/or communicated via signals transmitted over computer hardware and networks. The stored data may be reflected as unique data structures in physical memory units. As such, each embodiment disclosed herein results in physical transformations within each computer system as a result of performance of the method steps. The method steps may also be tied to particular computing machines, or components thereof, that are specially configured by one or more of the parties controlling or using the computer systems described herein.

Nothing in this specification or appended claims should be interpreted as stating that executable instructions under the inventive subject matter are stored as transitory waves or signals.

### Registration and Loan Qualification Profiling

In certain embodiments of the inventive subject matter, a computer system is configured to allow borrowers to register with the system, apply for lending (new or additional), and obtain funds without the need to complete traditional, detailed forms—either web-based or paper forms. All that is needed is that the user input some basic biographical information, such as name, date of birth, marital status, dependents, address, income, loan purpose, income, loan amount and bank accounts.

The system does this by obtaining the permission of the borrower for the marketplace operator to directly access both the verification data (or a processed assessment of such data) that is historically used to support the claims made by a loan applicant in their personal loan application, and other (non-traditional) data sources as deemed appropriate by the marketplace operator to assess the qualification of a borrower for a loan. For purposes of this document, the computer-automated profiling of potential or existing borrowers based on traditional or non-traditional loan qualification assessment factors may be referred to as a “no app loan” loan app. As used herein, unless context indicates otherwise, a “borrower” means a potential borrower or an existing borrower.

Accordingly the inventive subject matter is a technology and process to automate and generate a loan application. In lieu of a loan application or in addition to a loan application, the output of a data extraction and/or data processing operation may be an indication of a potential borrower's, or specified existing borrower's, approvability or worthiness or other qualification for a loan or qualification for changing terms of an existing loan. For example, in a computer system consisting of a central server in networked communication with one or more other computer systems of third parties storing verification data, a personal loan application may be generated from the verification data itself. And the system can then, according to predetermined criteria, automatically approve that loan application based on the reconstituted loan application. Therefore, the inventive subject matter goes beyond existing prior art involving automated form filling technologies by approving the loan using attributes/factors derived from the verification itself.

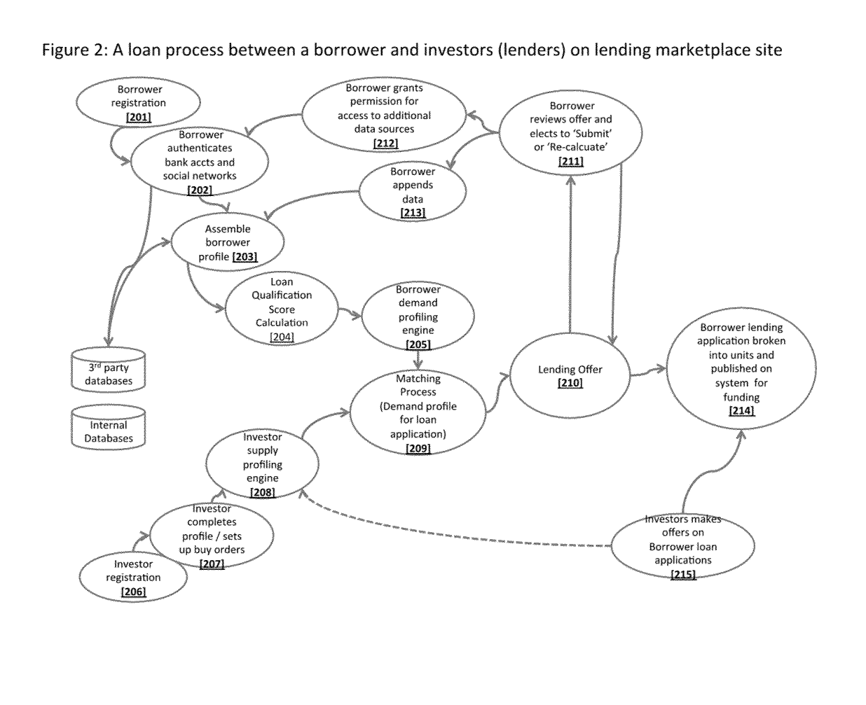

FIG. 2 is a diagram outlining the high-level loan processing steps, which may be carried out on a general or specific purpose computer and database systems configured with computer executable instructions representing or related to the contemplated steps.

The steps may include one or more of the following:
The borrower starts the process by registering with a central computer system [201] to create a user id and password. The borrower will nominate how much money they are seeking to borrower and basic loan terms (over how many years and the maximum rate they are willing to pay)
At [202] the borrower may be encouraged to register access by the system to their bank accounts, and provide permissions for the system to access their social network accounts (as nominated by the borrower). The system may be configured to allow for read-only access to third party sites, for security reasons.
Using the authorizations provided by the borrower, relevant data is retrieved from third party databases by the system. The central computer system is configured to automatically assemble the data in the form of a borrower profile [203], which is then processed to create a loan-qualification scorecard for the borrower.
The customer credit profile assembled [203] for the borrower may contain both traditional credit scoring data, such as credit bureau scores, and non-traditional data, such as behavioral attributes derived from bank systems and social networking sites. The behavioral attributes enable the borrower to be scored for evidence of behavioral based competencies relative to their peers at similar life-stages and calibrated against later life-stage groups (with longer, more stable credit history data). This solves significant limitations of current approaches that discriminate against loan applications that have limited credit history (e.g., due to applicant age, but also impacting immigrants, stay at home partners, etc.)
For each borrower, the system may store or generate a credit profile. In the inventive system, multiple borrower credit profiles would be stored or generated. A credit profile includes or is based on loan qualification assessment factors that are used in creating a loan qualification score for a borrower.
Behavioral-based competencies are assessed via analysis and scoring of the borrower's longitudinal financial data and social networking data under categories, such as (but not limited to) financial management, networking, advocacy, leadership and accountability.
As an example, a person's LinkedIn profile provides insight to their competency in areas such as networking (e.g., the number and profile of their connections), advocacy (e.g., evidence of recommendations), and leadership (e.g., posting behaviors and responses).

For example, consider two borrowers seeking loans; both aged 21 years, who have identical credit bureau risk scores and incomes. The first applicant is a graduate lawyer working for a major firm, with 100+ LinkedIn connections across both senior and junior level people. The second applicant works in a retail shop with no LinkedIn profile. If this information were made available to potential lenders, then many would find it valuable to discriminate between the two applicants. And, in all likelihood, the first applicant would generate more demand than the second, which would translate to more funding offers and potentially a better rate.

Where a traditional credit-scoring algorithm applied to the borrower credit profile would generate a single credit score that represents the likelihood that the borrower will default on a loan within a given timeframe, the inventive subject matter is a method of generating an overall loan qualification scorecard composed of a series of independently calculated sub-scores for a range of traditional and non-traditional behaviors. The scorecard rating for a given borrower may or may not in isolation directly correlate to the likelihood that the borrower will default on a loan within a given timeframe, but in aggregate provide lenders superior ability to assess borrowers for credit worthiness.

Therefore, in certain embodiments, a borrower's loan qualification score may be a composite score of at least four components: (1) credit bureau score; (2) current financial data; (3) financial management behavior scores; and (4) other behavioral competency scores. As an example, a borrower's composite score may be made up of a 40% weighting for the credit bureau score, a 20% weighting for the current financial data, a 20% weighting for financial management behaviors, and a 20% weighting for other behavioral competency scores.

Calculating a loan qualification score [204] using this approach has a number of benefits over traditional methods:
The scores are more accurate in discriminating credit worthiness, as a far wider set of relevant data is utilized.
Borrowers who have limited or credit history are able to be scored (based on their financial management and behavioral competency scores), and hence are not discriminated against
Lenders can be provided with more comprehensive and descriptive borrower credit profiles on which to make investment decisions

A set of processes performed by a borrower demand profiling engine [205] collates the profiles of all borrowers to determine the aggregate demand for credit in the marketplace, both in total and by segments of borrowers of similar credit profiles.

Investors registering with the system [206] are able to search for borrowers who meet their investment criteria and a set-up a range of notifications or automatic buy instructions based on criteria [207]. The investor's selection/criteria may be saved by the system as their stated risk criteria. In addition, the system may analyze lenders actual investment behavior to derive a learned risk criteria for a e lender. A set of processes at [208] collates investor profiles across an entire selected lending marketplace to determine the aggregate lender demand.

The set of processes at [209] matches together a collation of all demand for loans by borrowers by their risk profile dimensions to the aggregate supply of lending for corresponding risk dimensions. In doing so, the system is able to determine the level of lender-investment demand for any given borrower application.

If a borrower has an acceptable loan qualification scorecard (i.e., above a minimum threshold set by the marketplace operator or a lender) they are effectively approved to post their loan application on the system for funding by lenders at [210]. In this case, the borrower needs to set the maximum interest rate they are prepared to accept and the loan terms. If the borrower's pricing and loan term expectations are not aligned to investment return expectations of lenders then the marketplace will fail to operate efficiently (i.e., borrowers will post loan applications that are not funded by lenders, or take a very long time to achieve funding). To facilitate borrowers to make efficient trade-off decisions between the interest rate and loan terms they are prepared to accept versus the likely funding time, they are provided with recommended loan pricing and information about the level of lender demand for their loan application both at the recommended loan price and above and below.

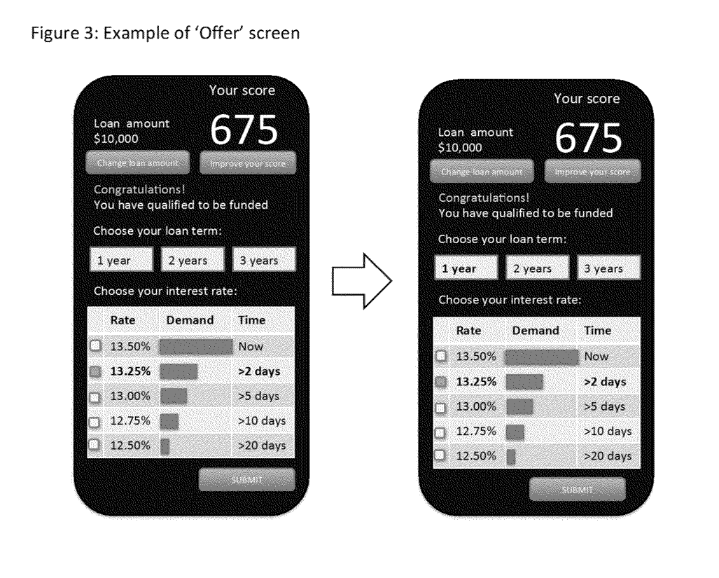

FIG. 3 shows a screen shot of an example lending offer presented to a borrower at [210]. In this example, the screen (GUI) is for a mobile or handheld device but it could be for any other computer system. Using the GUI, a borrower may elect to nominate their loan terms and submit the application for funding [211]. Alternatively, borrowers have the option to have their score on a scorecard re-calculated by either authorizing more databases to be used in the calculation [212] or providing additional information themselves [213].

FIG. 3 is just one example of a GUI that may be used with the inventive subject matter. As persons skilled in the art will appreciate, the method steps disclosed herein may implemented through any number of interactive features associated with GUIs. The GUIs would generally be provided as executable instructions or code and/or web markup languages, such as HTML or XML (also considered executable instructions or code for purposes of rendering GUIs). For example, a central computer system hosting borrower credit profiles and investor profiles could transmit such instructions to a borrower computer. The borrower computer system then processes the instructions and renders a GUI on the borrower's computer system that the borrower can interact with to input personal data used to create or update a borrower profile. The GUI instructions include instructions for transmitting the data back to the central computer system for processing and/or storage in a borrower's credit profile.

The requested or stated amount in a loan application is may be split into fractional units [214] so that it may be offered for funding too many lenders simultaneously. The loan application may then be published on the system for funding by lenders via, for example, an auction process [215].

### Predictive Loan Qualification Scores, Dynamic Pricing

In other respects, the inventive subject matter is directed to a personalized loan application via a variable rate loan that is not necessarily pegged to interest rates but to a set of behavioral factors or other loan qualification assessment factors. The behavioral factors data may be discerned by tracking behavioral attributes of the individual or commercial borrower through time and/or gleaned from the same sources for verification data used to generate the “No loan app” loan app, according to the inventive subject matter disclosed herein.

The inventive subject matter also eliminates the need to create a locked-down personal loan rate. Instead, it provides borrowers with an incentive to behave in ways that are consistent with reducing their perceived credit risk to the institution providing their loan. For example, the inventive subject matter contemplates use of a set of predetermined criteria, discussed in more detail below, that create a dynamic score (for example a score on a scale of 1-1,000) that may be derived from predetermined factors, such as some or all the factors used to determine the loan qualification score of a new loan applicant and/or a borrower with an existing personal loan. In this way, the inventive subject matter enables a borrower to receive dynamically priced personal loans that reflect their changing needs and circumstances. Also in this way, a loan applicant or borrower may start with a C-rating and may progress to a B-rating, and improved rate or other loan terms, as the applicant or borrower consolidates debt, receives a promotion, or increases their savings rate, for example.

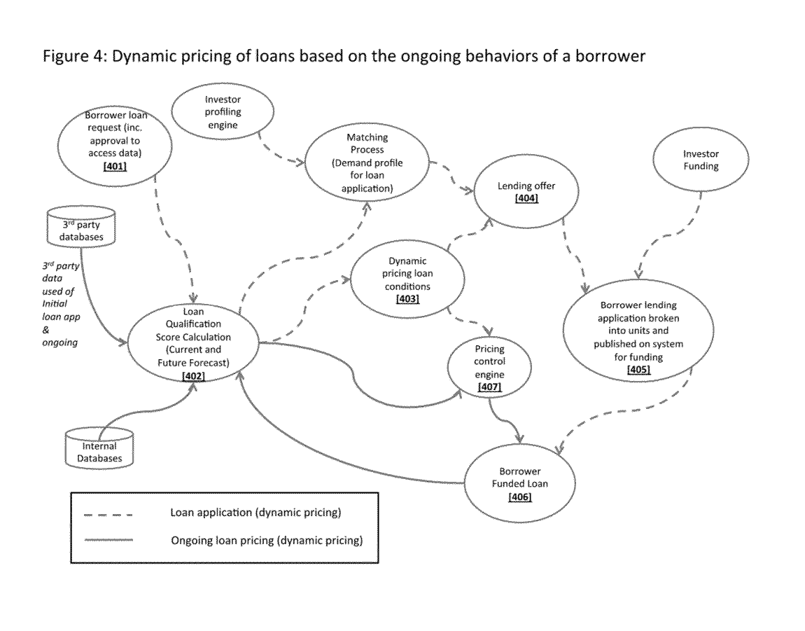

FIG. 4 is a diagram outlining the process of providing dynamic pricing of loans based on the ongoing behaviors or other loan qualification factors of a borrower. The process may include the borrower making a loan request and approving access to third-party data that is indicative of borrower behavior and credit scoring [401].

The computer-automated steps may include one or more of the following:
The processes and algorithms that calculate a borrower's loan qualification score [402] may also calculate a forward-looking projection of the borrower's score. As an example, the borrower's loan qualification score may take into consideration the probability of someone in their employment field/industry becoming unemployed and being unable to find new employment as one factor to assess an overall score. In this case, the completion of additional professional certifications and qualifications may be taken as indicative of the borrower having a diminished future probability of either becoming unemployed and/or being unable to find work, and likely to have an improving loan qualification score in future. A future loan qualification score could be derived to quantitatively predict a lower future probability of default and therefore justify the basis for establishing a dynamic pricing offer that gave benefit to the borrower.
In any case, the system may produce, in addition to a recommended pricing offer as described in FIG. 2 above, a set of dynamic loan conditions [403] that enable the pricing or other loan terms to vary over time provided that the borrower meets prescribed behavioral conditions, both in relation to the repayment of the loan and other behaviors.
These conditions may include the effective discount schedule that the borrower would be eligible to receive, and the corresponding loan repayment conditions they would need to achieve.
It also may include the penalty schedule (i.e., pricing implications for failing to meet required loan repayment standards)
A borrower may be presented with the option of dynamic pricing as part of the lending offer [404; as per 210 in FIG. 2] if they are approved by the system.

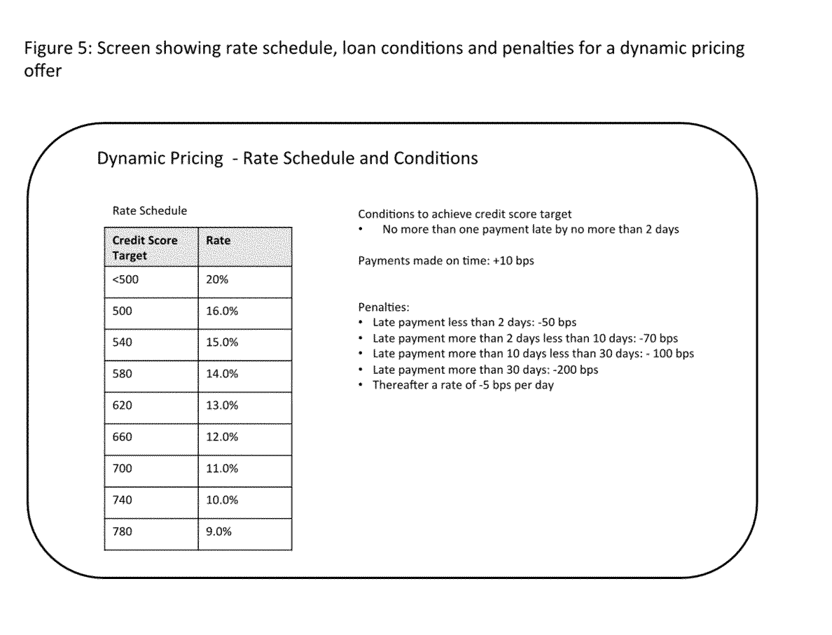

As per FIG. 5, a dynamic pricing offer may have the structure of a starting rate of interest, a target end rate of interest, and a set of terms and conditions providing a guide of loan qualification score movements for a range of behaviors. These interest rate figures may be determined by a computer system based on the current loan qualification score of the borrower and the forward-looking loan qualification score.

In practice, the borrower is able to achieve the target end interest rate by ensuring their repayment behavior is within the conditions outlined. Conversely, if the borrower's loan qualification score deteriorates their interest rate may increase under this model for dynamic pricing.

A borrower may elect to submit a loan application utilizing the dynamic pricing offer, and the loan application will be split into units and posted on the system [405] and distinguishable to lenders as a dynamic pricing offer.

Once funded [406], the loan qualification score of the borrower will continue to be periodically re-calculated [402]. The dynamic loan pricing conditions [403] are made available to a pricing control engine [407]. This price control engine for a set of processes [407] will reference the borrower's loan qualification score over time [402] and update the loan terms in line with the agreed dynamic pricing conditions [403].

As an example, a potential borrower is a young applicant who has completed a degree in law and is between the ages of 18 to 22, with a high grade point average, and commenced an internship with a law firm at the age of 23. The applicant was scored with a current loan qualification score of medium to low (i.e., B grade). However, using the inventive methods discussed above, the system has identified a correlation between both the potential borrower's sequence of academic and career events, and the timing between them to categorize them as a “continuous-improvement” behavior pattern that has a correlation to an improving rate of creditworthiness. Consequently, the potential borrower is scored as having a forecasted loan qualification score of high (i.e., A grade) in 3 years. A pricing engine in the computer system would then provide the potential borrower the option to nominate a “dynamic” pricing rate, whereby the potential borrower would be offered an initial rate that corresponded to a B+ customer, which rate would be adjusted to a target rate corresponding to an A-grade customer of the term of the loan. However, this adjustment would be conditional on the borrower meeting repayment behavior standards (in line with an A-grade customer). If the customer failed to meet repayment behavior standards, they would risk the penalty of being re-priced to a higher rate.

### Investor Custom Scorecard and Automated Loan Funding Instructions

In still other respects, the inventive subject matter is directed to computer systems and methods that allow a lender or investor to customize the criteria and/or weighting of criteria used to generate a loan application or rate the approvability or worthiness of a potential borrower or existing borrower for a loan, or changes in the terms of an existing loan.

As described earlier, a borrower's loan qualification score may be composed of a number of scored and weighted sub-components, such as (but not limited to): (1) a credit bureau score; (2) current financial data; (3) financial management behavior scores; and/or (4) other behavioral competency scores. Lenders will have access to one or more of the borrower's composite loan qualification score, sub-component scores and details of profile attributes that are included in the sub-component scores. For example, a sub-component of a borrower's score may be a behavioral competency of “advocacy”, which may include an attribute of “LinkedIn recommendations.”

This level of detail about the borrower, and the basis on which their loan qualification score has been calculated, benefits the lender by providing a comprehensive understanding of scoring mechanism (which they may agree or disagree with), and the option of developing a far deeper understanding of the profile of potential borrowers compared to traditional scoring methods.

In certain embodiments, in providing this level of detail to lenders, the system/marketplace operator recognizes that, to best achieve its role of facilitating lending among borrowers and lenders, it must allow lenders to apply their own risk criteria/bias in discriminating amongst potential borrowers.

Hence the system provides the option for lenders to create a custom scorecard that represents their personal assessment of borrowers by adjusting the selection and/or weighting of sub-components, or attributes within sub-components.

In certain embodiments, a significant benefit for lenders is that they are able to view loan qualification scores for borrowers based on both the traditional credit rating and their own, customized customer scorecard, providing them a unique and highly efficient mechanism to score, rank and price potential borrowers. This also benefits the marketplace as it creates greater diversity of funding opportunities.

Lenders are able to use, either in isolation or in combination, their own custom scorecard, the traditional marketplace credit ratings, and/or selected borrower credit profile criteria to search and view, and at their discretion, set automatic “watch” or “buy” funding instructions through the system host [703].

### Loan Slicing Based on Profiling, Demand Matching & Pricing

In other embodiments the inventive subject matter is directed towards methods of creating trading efficiency among borrowers and lenders present in the marketplace by optimization of loan slicing and auctioning based on the characteristics and dynamics of supply and demand of credit.

The lending marketplace can be considered as a credit ecosystem with measurable characteristics, such as one or more of the aggregate level and profile of lender supply of credit [208]; the aggregate level and profile of borrower demand for credit [205]; the nature of loan terms being sought by borrowers and lenders [210/215]; the degree to which investors are able to invest available funds in the market; and the degree to which loan applications are funded; and measurable marketplace dynamics, such as the time taken for loans to be funded and flow rates of new lenders and borrowers coming into the marketplace. Accordingly, the inventive subject matter provides systems and processes to utilize a wide range of measurable system characteristics and dynamics, as described above, to determine how to best slice each loan into fractional units for the purpose of being offered to lenders, and how to best auction each loan to such investors. In doing so, the system/marketplace operator seeks to best match supply and demand of credit within the marketplace to create optimal utility for participants, i.e., to enable lenders to achieve attractive returns; to enable borrowers to obtaining lending at attractive rates; to allow maximum participation in the marketplace; and to minimize the time taken for deals to be finalized.

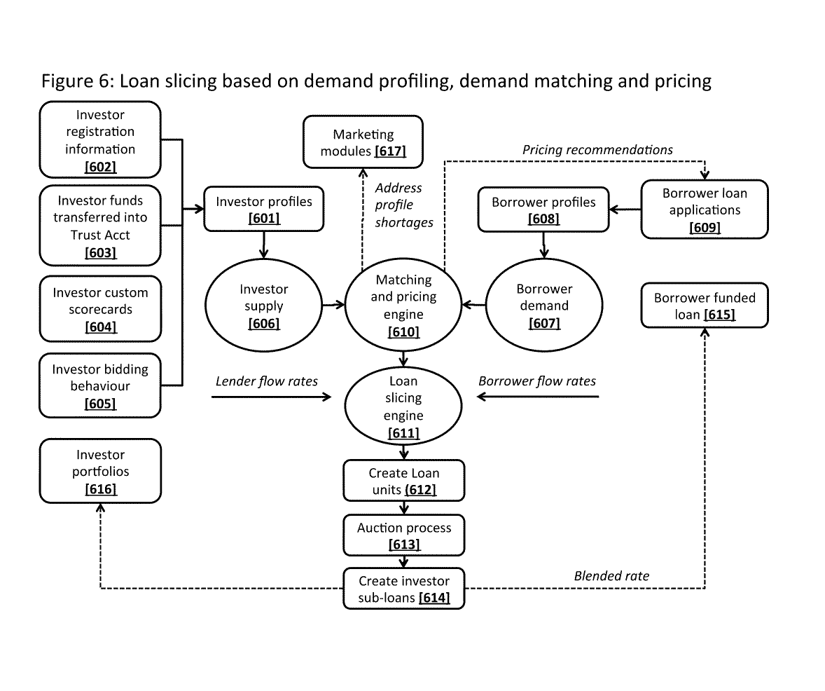

FIG. 6 is a diagram illustrating a method of sharing intelligence between functions within the system for the purpose of creating greater utility for marketplace participants.

As an example of the approach, consider first that the investor market might contain lenders of various characteristics, ranging from (but not limited to): (1) small-scale, self-managed individual investors with low risk appetites, seeking an alternative option to savings accounts to (2) large-scale investment managers handling the investment portfolios of high net worth individuals who are seeking higher returns and have a greater risk appetite. Also, consider that the small-scale investors may be large in number, but relatively small by amount invested. On the other hand, the large-scale investment managers might be small in number, but very large by amount invested. Investor profile characteristics such as these would be detected at operation [601] by analysis of one or more of: information from the investor registration information [602]; the nature and amount of investor funds being transferred into trading accounts [603]; investor custom scorecards [604]; and actual investment behavior [605]. The investor profile information would be collated at process [606], along with the flow rates to determine the current and near-term investor supply of funding, both in aggregate and by segments (as per the examples above).

In parallel, consider that the loan market might contain borrowers ranging from (but not limited to): (1) high quality, low-risk borrowers with excellent credit history seeking the lowest rate to (2) medium-to-high-risk borrowers who place less emphasis on price. In this example, consider that there are far more medium-to-high-risk borrowers in the marketplace than low-risk borrowers. Again, a similar operation of collating overall current and near term borrower demand [607] based on analysis of borrower profiles [608], which in turn have been derived from borrower loan applications [609], may be performed.

In this example, the matching and pricing operation [610] may determine (based on intelligence from investor supply information [606] and borrower demand information that the relatively small number of low-risk borrower loans are most attractive to the large number of small-scale (low risk) investors/lenders; whereas, the large number of medium-to-high-risk borrower loans are most attractive to the small number of large-scale managed investors. This intelligence would then be passed to the loan slicing engine [611], which accordingly would slice any given requested or stated amount in the low risk loan applications into a large number of small units [612] corresponding to the many small-scale investors, and, in conjunction with risk-profile information, slice any given requested or stated amount in the medium-to-high-risk loan applications into a smaller number of units to enable efficient funding by the small number of large-scale investors. In addition, the loan-slicing engine [611] would seek to determine the most appropriate type of auction process [613]. For example, auction processes may include (but are not limited to): funding of a borrower's loan from existing pre-set lender bids within the system; posting of a loan application on the system to attract new bids from lenders; or a combination of these processes.

Borrower loans are created at operation [615] following the creation and collation of investor-funded units into distinct sub loans for each lender [614]. These sub-loans are priced at the rates offered by the investor. In collating the range of investor offers to fund a loan, the system is configured with instructions to ensure that the blended rate of all investor offers is within the maximum interest rate nominated by the borrower.

On the investor side, sub-loans created at [614] would be aggregated for each investor to create their total investment portfolio [616].

In doing so, the system would seek to best satisfy the needs of all lending and borrowing participants in the marketplace, as well as minimizing the time taken for deals to occur.

As part of the matching and pricing operation at [610], borrowers may be provided with information about the level of supply of lender funds for their loan to enable them to adjust their price expectations in line with the marketplace.

If at operation [610] an undersupply of a particular profile of borrower or lender/investor is identified, the information is input into marketing modules at [616], which may create appropriately targeted campaigns (discussed below) Likewise, oversupplies of a particular profile of borrower or lender/investor will also be passed to the marketing module, which may defer or suspend further campaign activities targeted at these particular lenders/investors.

### Marketing

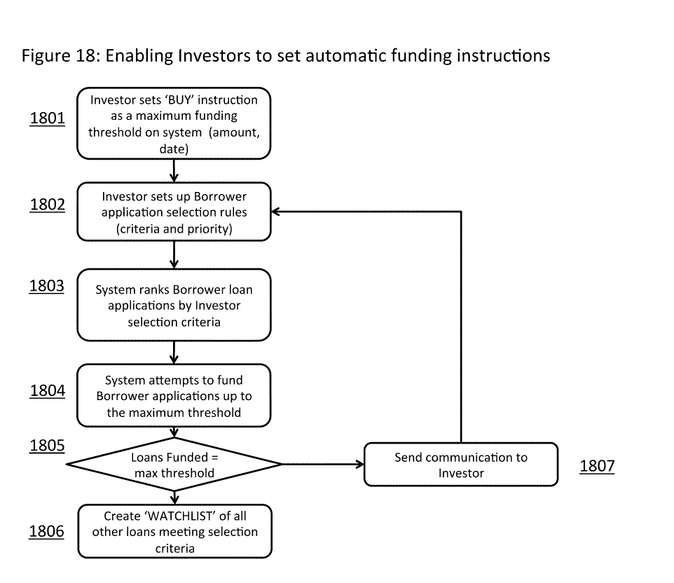

In other embodiments the inventive subject matter is directed towards systems and processes of attracting new borrowers and lenders into the marketplace, or stimulating latent demand amongst existing marketplace participants to balance overall supply and demand for credit. Accordingly, a process to achieve this may include computer executed one or more steps for lenders to:
1. Identify borrowers who meet their investment criteria via the methods of setting up automatic watch or buy instructions (FIG. 18);
2. Create a list of existing borrowers in the marketplace (i.e., funded loans in place); and
3. Identify potential borrowers outside the marketplace who meet their criteria

Investors would also have the option to present offers to customer within the three categories (above). For example, one or more of the following options may be generated by the system and presented to borrowers:
1. Prospective borrowers in the marketplace—pre-approved offers to these customers;
2. New prospective borrowers entering the marketplace—passive pre-approved offers in place and offered as the new borrower enters;
3. Existing borrowers—Notification of pre-approved offers for additional lending; and
4. Prospective borrowers outside the marketplace—passive, pre-approved offers.

The inventive subject matter contemplates facilitating the marketing of funding offers by investors to prospective and existing borrowers either via the marketplace platform, or, in the case of prospects outside the platform, via online marketing.

The inventive subject matter also contemplates that investors who have generated a list of prospects outside the platform may nominate the marketing budget they are prepared to spend to place a pre-approved funding offer to these borrowers.

The inventive subject matter also contemplates creating online marketing campaigns and bid on advertising directly to those customers on behalf of the investor up to their set budgets.

In cases where the prospect responds to the offer, the inventive subject matter further contemplates managing the campaign process to acquire them on behalf of an investor or pool of investors.

All the foregoing services may be managed and handled via an intermediary party operating a central computer system in networked communication with one or more investor computer systems. The intermediary party may provide graphical user interfaces for interacting with the investors and presenting information related to borrowers, lending offers, loan transactions, and changes in borrower loan qualification assessment factors, and changes in loan terms.

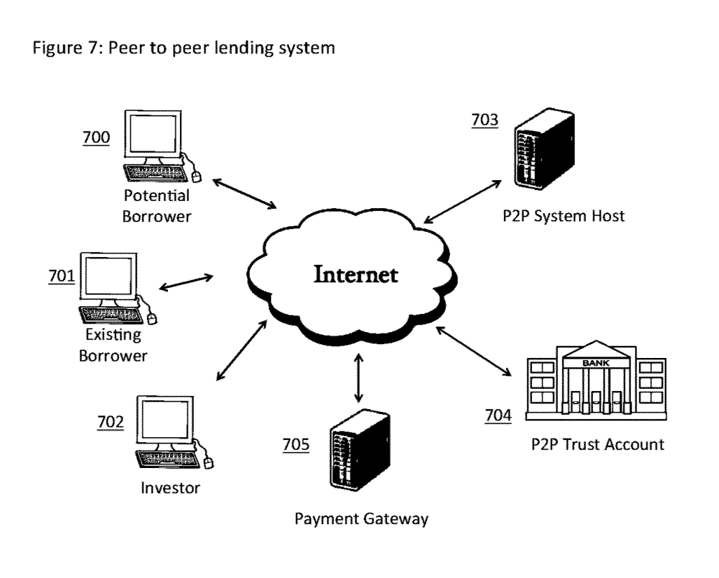

FIGS. 7-20 are further representative examples illustrating principles of the inventive subject matter and various embodiments of the inventive subject matter, which may stand alone or in various combinations with one another.

FIG. 7: An Exemplary Peer-to-Peer Lending System

Some possible features of a peer-to-peer lending system include one or more of the following, alone or in various combinations.
Potential borrowers [700], existing borrowers [701] and investors [702] can interact with the peer-to-peer lending system via a P2P system host (central) computer system [703] over an Internet or other data network connection.
The system enables potential borrowers to create and submit loan applications that can be viewed by investors and other lenders on their respective computer systems, who in turn may choose to fund the loans in return for agreed repayment terms (i.e., the borrowers and investors agree on at least interest rates and loan period).
Existing borrowers may be enabled to see details of their loan accounts on the system and seek new lending via their computer systems and associated graphical user interfaces, which are stored locally or downloadable from the system host (central) computer system [703] on demand. The central computer system may also store other software components that are downloadable to systems [701] or [702] of borrowers or lenders and provide instructions for performing steps according to the inventive subject matter disclosed herein, including the enabling of online interaction between the parties. System host [703] may also have stored software that enables it to interact with and serve as an application service provider to borrowers and lenders with respect to steps according to the inventive subject matter disclosed herein.

Some possible basic aspects of the system with respect to enabling lending among borrowers and investors include one or more of the following, alone or in various combinations:
Automated creation of the borrower's loan application by retrieval of data from disparate systems (rather than the borrower inputting information into a form).
Assessments of the creditworthiness of the borrower to enable investors to make informed decisions about the default risks of the borrowers and likely investment returns.
Risk assessments of the creditworthiness of borrowers makes use of a wide set of traditional data sources, such as credit bureau scores, current bank statements and assets values, and of new data sources, such as banking integration sites (e.g., Yodlee) that provide direct, preferably read-only access to bank account and social networking sites (e.g., Facebook, LinkedIn, Twitter, etc.). Consequently different analysis approaches such as analysis of behavioral patterns across a number of competency areas (e.g., financial management, advocacy, networking, etc.) may be used to derive, relative to traditional credit scoring, a more accurate assessment of the borrower, particularly among particular market segments.
Investors may create and use custom scorecards to apply their own risk assessment criteria in evaluating potential borrowers. This allows for greater diversity of personal risk/reward trade-offs within the marketplace.
The system may provide relevant information to both borrowers and investors to facilitate efficient operation of the marketplace in terms of the pricing of loans and the duration of time from a loan application being made to being funded.
   The system may also facilitate investors to (proactively) identify potential and existing borrowers who meet their investment criteria, and hence further facilitates the provision of credit to creditworthy borrowers.

Many investors may fund each loan, so a single investor has a fractional interest in any given loan. The system may manage all aspects of the loan being broken into many parts and distributed across many investors, such as collation of investor funds into the initial loan payment, distribution of borrower repayments back across many investors, communication to all investors about the status of the loan, etc.
Investor funds may be held in a trust account associated with the P2P provider [704].
Once a loan application has been funded by investors funds a loan account may be created and funds may be transferred via a payment gateway [705] from the investor accounts within the trust account to the borrower's nominated bank account.
Loan repayments made by borrowers may be split into the fractional interests and credited to the Investor's accounts within the Trust Account.

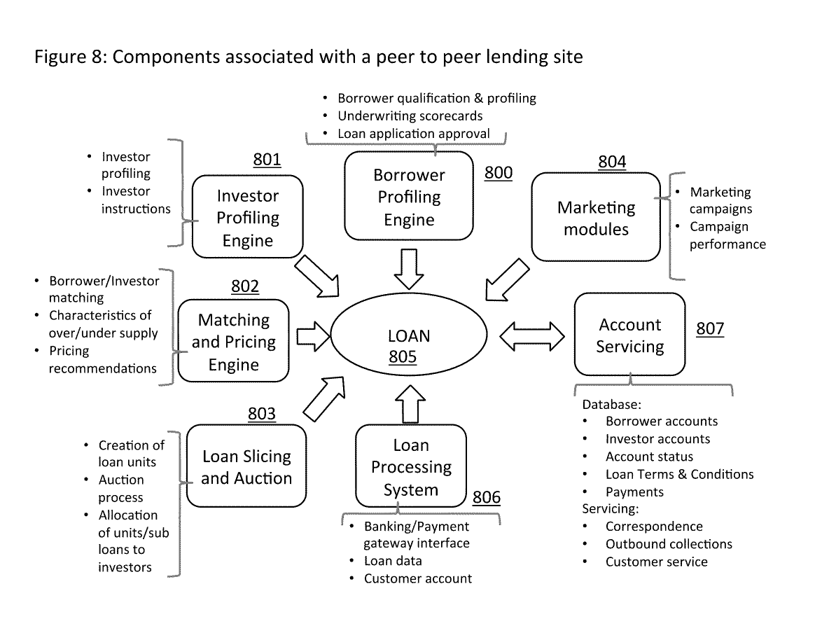

FIG. 8: Components Associated with a Peer-to-Peer Lending Site

Some possible components of a peer-to-peer lending site include one or more of the following, alone or in various combinations.
The borrower profiling engine [800] contains a credit underwriting engine that may provide information required to assess the creditworthiness of a potential or existing borrower.
The underwriting engine may extract customer data from disparate third-party systems, including: credit bureau (e.g., Veda, Experian, Transunion), AML, the borrower's bank accounts, social network sites (e.g., LinkedIn, Facebook, Twitter), and the borrower's existing accounts within the P2P lending site.
The borrower's data retrieved from the various systems may be processed to create a credit profile for each borrower.
The underwriting engine also contains the credit risk models that are applied to the borrower's credit profile data to create loan qualification scores used to assess the creditworthiness of the borrower.
Information about investors and their profiles with respect to the profiles of borrowers and loan they are seeking to fund are stores in the Investor Profiling engine [801].
The process at [802] may periodically or continually monitor and match the borrower demand for loans against investor supply of funding, and in doing so provide information back to both borrowers and investors that facilitates optimal efficiencies within the marketplace (i.e., borrowers are able to post loan applications at rates which are funded in reasonable time periods, and investors are able to efficiently identify loan applications that that meet their investment criteria).
The process at [803] manages the process of splitting loans into units for the purpose of an auction process and allocation to lenders in a way that optimizes the efficiency of the marketplace
Characteristics of marketplace credit over and under supply (for example, an under supply of a particular class of borrower) are sent to marketing modules at [804] that execute campaigns targeting acquisition or upsell of specific borrower or lender (investor) profiles in order to balance marketplace credit supply and demand
These components may combine in various ways to facilitate the efficient loan market place [805] between borrowers and investors.
The processes associated with account service module [807] are typical processes associated with the provisioning of new loans and ongoing operations.

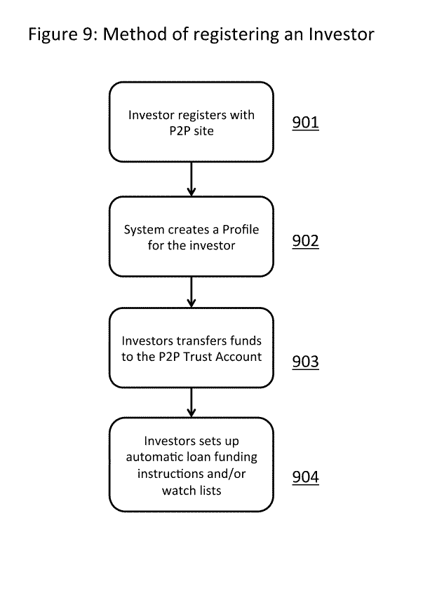

FIG. 9: A Method for an Investor to Register with the System

Some possible features of a method for an investor to register with system host [703] include one or more of the following, alone or in various combinations.
Before an investor can fund loans, they need to register with the central computer system [901]. As part of the registration process, the system may perform security checks, such as Anti Money Laundering (AML) screening.
The system may create an profile for the investor [902] based on information provided in the registration process [901], as well as subsequent information appended to the profile based on information updated by the investor, and/or information derived through investment behavior
The system may create an account for the investor within the trust fund [903], which they may transfer money into to enable them to fund borrowers or partake in other transactions.
At the time of registering, the investor may be enabled to create a profile of the borrowers they are interesting in investing in, as well as set up “buy” and “watch” instructions to identify and fund loans that meet their investment criteria [904] (discussed in more detail in FIG. 18).

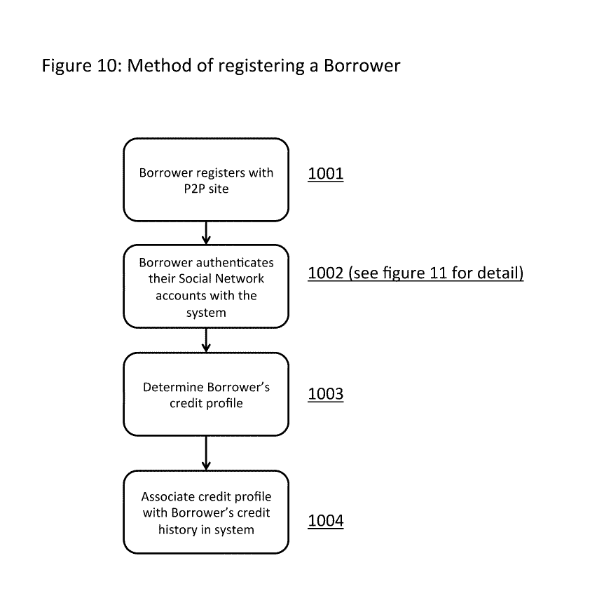

FIG. 10: A Method for a Borrower to Register with the System

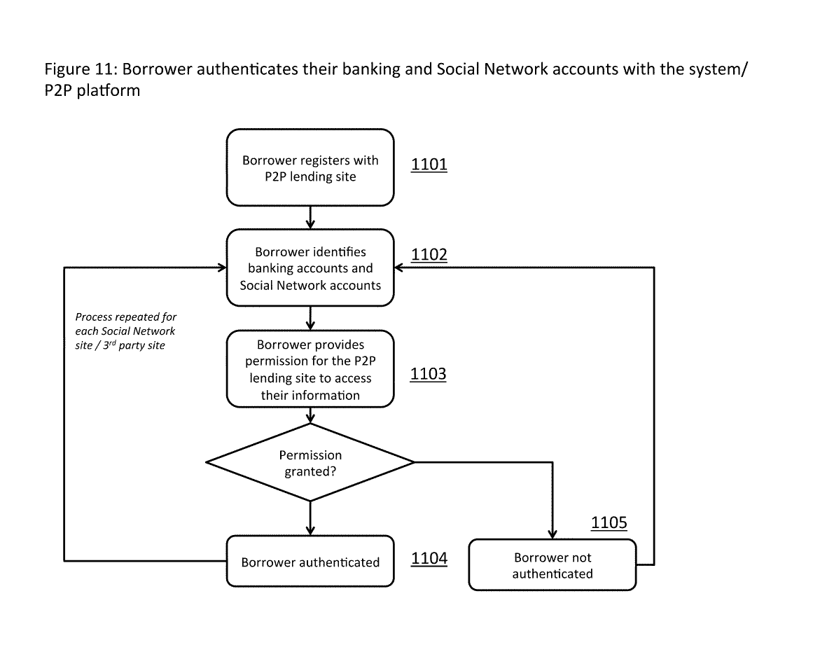

Some possible features of a method for a borrower to register with system host [703] include one or more of the following, alone or in various combinations.
Before a borrower can seek a loan from investors the borrower must first register with the system.
The registration process allows the borrower to make themselves known to the system, and, in doing so, to be established with a credit profile that will enable them to seek lending.
The initial registration [1001] may require the borrower to create a user id/password for the system and supply basic information to enable security checks as required by government or private regulations (e.g., AML).
Once registered, the borrower may be encouraged to register read only access to their banking accounts (via an account aggregation service, such as Yodlee) and access to their social network accounts with the system [1002] [FIG. 11]. This registration process has many benefits for both the borrower and investors:
   For the borrower it allows information about them to be extracted automatically rather than needing to be typed into the system.
   It facilitates a wider set of data to be used in their credit profile. This is particularly applicable for segments of customers such as younger borrowers who have little or no credit history.
   The use of a wider set of data that is behavioral in nature creates a borrower credit profile that is more descriptive to potential investors and facilitates better funding decisions to be made.
   The borrower's credit profile may be continually updated automatically based both behaviors internal to the system (i.e., repayments of loans) and external (such as overall financial accounts, changes to employment, etc.), enabling the creation of new behavior based pricing models that benefit both the borrower and the Investor (more detail in FIGS. 4&5).
The system creates a credit profile for the borrower [1003] by retrieving and compiling information about the borrower's history relevant to their use of credit. The credit profile may be used to create a loan qualification score for a borrower.
At [1004] If the borrower is an existing or past customer of the system [703] their internal data (e.g., repayment of existing loans) may provide significant insight and may be associated with the external data to create of an integrated credit profile for the borrower

FIG. 11: The Borrower Associates their Loan Qualification Data Sources, e.g., Banking and Social Network Accounts, with the System

Some possible features of a method for a borrower to associate their third-party scorecard-related data sources with system host [703] include one or more of the following, alone or in various combinations.
On registering with the site [1101], the borrower may be offered a list of banking aggregation and social network sites to associate with their account [1102].
In doing so, the borrower goes through a direct or indirect process with each site (e.g., via a pop up window) whereby they (or the central computer system as a proxy for the borrower) logs in to the site and provides permission [1103] for the P2P lending site to access their information via an API [1104].

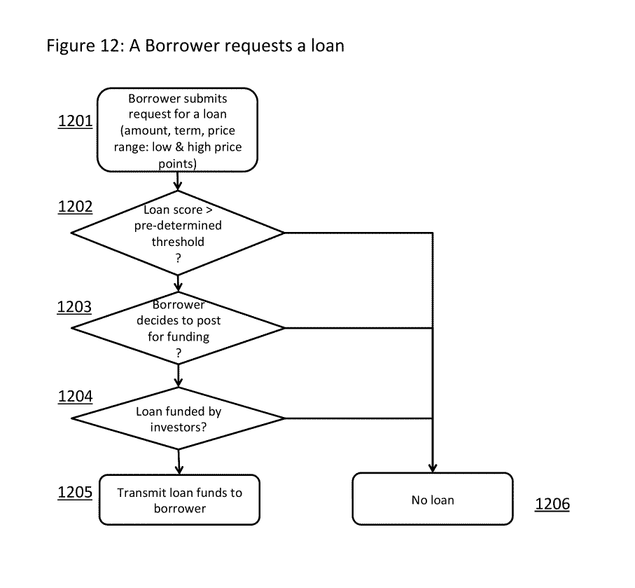

FIG. 12: A Borrower Requests a Loan

Some possible features of a method for a borrower to request a loan via a system host [703] include one or more of the following, alone or in various combinations.
The lending process may begin with a registered borrower submitting a loan request on the system [1201]. The information required at this point is typically the amount of lending they are seeking, the term of the loan (e.g., 1, 2, or 3 years), and an indication of the interest rate they are seeking, which may be expressed as low and high points of a range.
The system determines a loan qualification score, i.e., the creditworthiness of the borrower, with specific respect to their loan application via the calculation of a loan score [1202] using credit profile information stored by the system or generated by it on demand. The borrower's loan application is deemed to be creditworthy if the loan qualification score is above a threshold, and they are then given the option to post it on the system [1203] where it can be viewed and funded by one or more investors.

One purpose of approving the loan application for funding [1202] is to enable some form of regulation of the loans marketplace, particularly in terms of the general quality of loan applications on the system.
At step [1203], a borrower may decide to post their loan application. The borrower may be provided with information about the likely time to obtain funding for price points within their range (as per FIG. 3). This information enables the borrower to make an informed decision about the best interest rate at which to set their loan application relative to their desired timing for funding, for example.
At step [1204], investors can assess details of the borrower's loan application (including, for example, relevant, de-identified details from the borrower's credit profile) and decide whether or not to fund the loan. In certain embodiments, as discussed elsewhere, the inventive subject matter contemplates that multiple investors must collectively fund a given loan. In such a system, since any given investor is able to fund only a fraction of the loan, multiple investors must choose to fund a loan before the borrower's desired loan amount is obtained.
At step [1205], once a sufficient number of investors commit to funding a borrower's loan application so that the requested loan amount is achieved, the system [703] may create a loan account for the borrower on the system, debit funds from the trust accounts of investors, and transmit the funds to the borrower's nominated bank account.

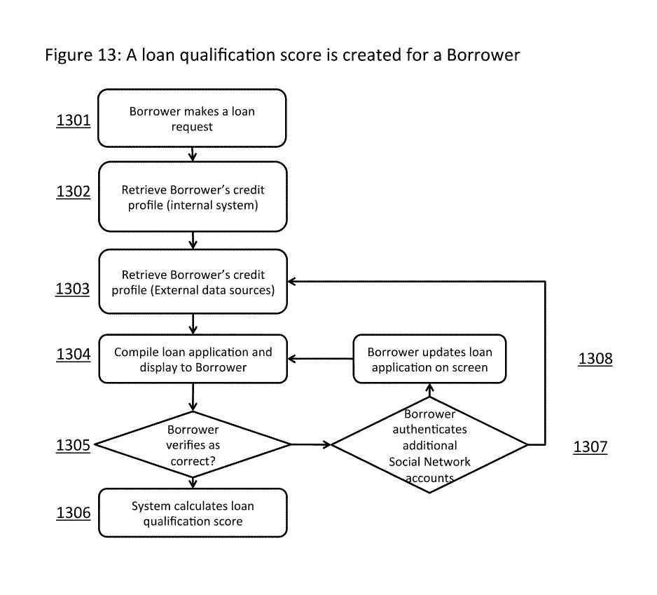

FIG. 13: A Loan Qualification Score is Created for a Borrower

It is common practice for companies offering lending to potential borrowers to use credit bureaus, personal details (e.g., employment status, job title, living situation, etc.), and the current financial statements in deciding to approve a loan. In certain embodiments of the inventive process, the system enables investors to make funding decisions based on the traditional information above, and additional information not (typically) used elsewhere. This may include use of temporally longitudinal financial data (i.e., rather than a point-in-time snapshot) and social network data that is then analyzed to identify behavior based competencies exhibited by the borrower:
The benefit of using longitudinal financial data is that it provides much greater insight on factors such as the stability of a borrower's income and expenses over time, and their ability to budget and manage money over a period of time.
Identification and measurement of behavior-based competencies allow borrowers to be assessed relative to their peers at similar life-stages and calibrated against later life-stage groups. This solves significant limitations of current approaches that discriminate against loan applicants who have limited credit history (principally due to age, but also significant to immigrants, stay at home partners, etc.).
Behavioral based competencies are assessed via analysis and scoring of the borrower's longitudinal financial data and social network data under the categories of, for example, Financial Management, Networking, Advocacy, Leadership and Accountability.
As an example, a person's LinkedIn profile provides insight to their competency in the following areas: networking (e.g., the number and profile of their connections), advocacy (e.g., evidence of recommendations), leadership (e.g., posting behaviors and responses), etc.

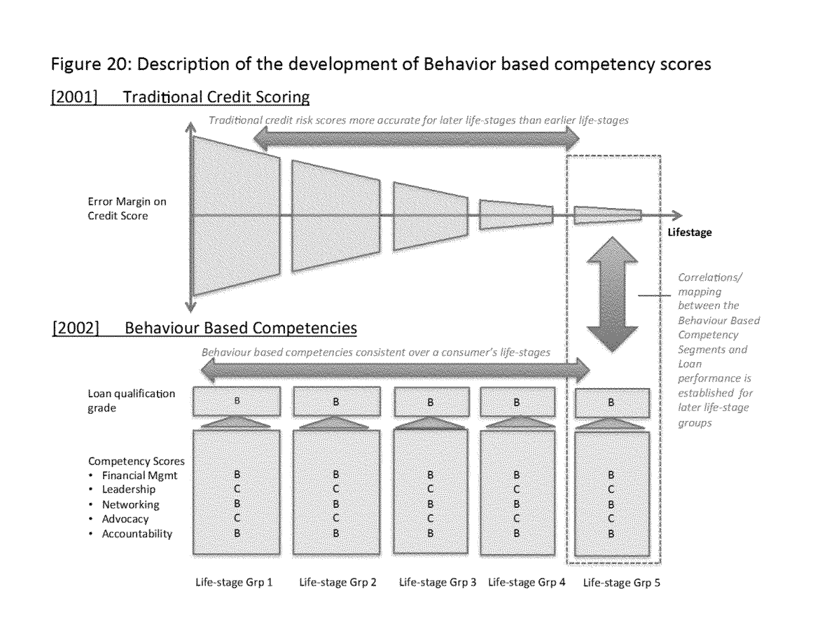

Further details of the method of calculating the behavioral competency scores are shown in FIG. 20. For example, consider borrowers seeking loans aged 21 years, who have identical credit bureau risk scores and incomes. The first applicant is a graduate lawyer working for a major firm, with 100+ LinkedIn connections across both senior and junior level people; while the second applicant works in a retail shop with no LinkedIn profile. The additional information made available is valuable to potential investors to discriminate between the two applicants, and, in all likelihood, the first applicant would generate more demand than the second, which would translate to more funding offers and potentially a better rate. Therefore, the borrower's loan score may be a composite score of at least three components: (1) credit bureau score, (2) current financial data and (3) behavioral competency scores. For example, a composite score might be made up of a 50% weighting for the credit bureau score, 20% weighting for the current financial data and 30% weighting for behavioral competency scores. These weightings can be made transparent to both borrowers and investors. The weighting may even be customized by investors wishing to create their own scoring models (discussed elsewhere, FIG. 10).

The process of creating a loan score for a borrower may begin with the borrower making a loan request [1301] (with the process as per FIG. 12), and the system retrieving the borrower's credit file, made up of internal data [1302] (if they are an existing customer of the system) and external data [1303].

The borrower's credit profile, in conjunction with the specific loan request, form the basis of a loan application that is auto-generated by the system [703] and which may be displayed to the borrower [1304] via online communication.

The borrower reviews the loan application data and has the option to update or correct information. For example the system has extracted data from LinkedIn including their job title, which is out of date; so, the borrower has the option to update the piece of data by either authenticating additional social network accounts [1307], such as LinkedIn, and refreshing the application, or manually updating the data within the application [1308].

If the application data is correct and verified [1305] by the borrower, they submit their lending application and the system calculates a loan qualification score for that application [1306].

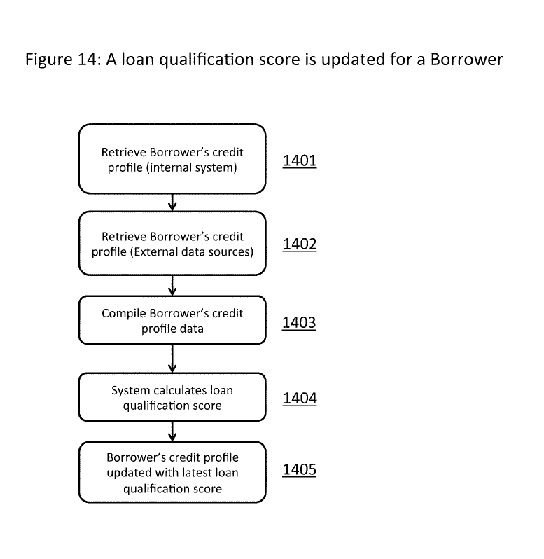

FIG. 14: A Loan Qualification Score is Updated for a Borrower

Some possible features of a method related to a loan qualification score update for a borrower through host computer system [703] include enabling an existing borrower's credit profile data [1401, 1402] to be retrieved, compiled [1403], and a loan qualification score recalculated [1404] and to be updated at any time. Over time, a borrower's loan qualification score may improve or decline based on their repayment behavior on their current loans on the system, credit behavior on other products outside the system, and more generally by their behaviors as measured by the behavioral competency scores. The system may regularly recalculate the borrower's loan qualification score and update their credit profile [1405]. Accordingly, the inventive subject matter provides the basis of new dynamic pricing models between borrowers and investors.

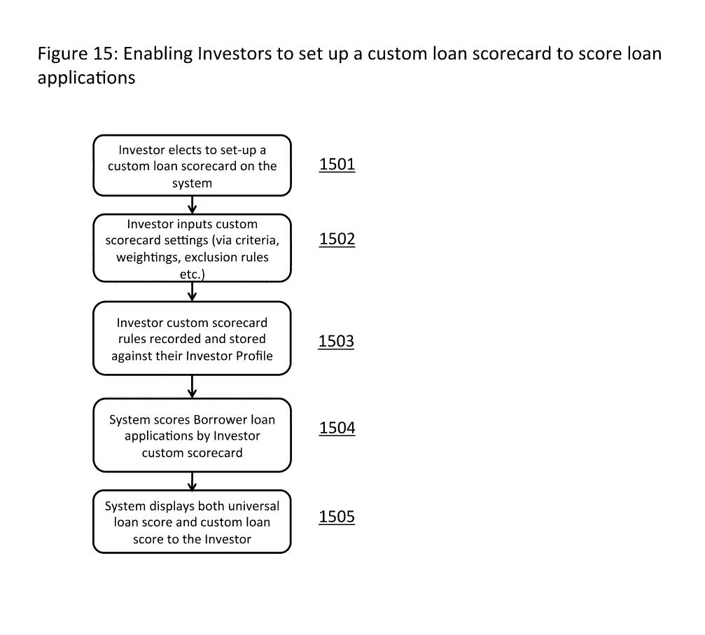

FIG. 15: Enabling Investors to Set Up a Borrower Loan Scorecard to Score Loan Applications

Some possible features of a method for investors and other lenders to setup a scorecard for loans through system host [703] include a loan-qualification scoring process that recognizes that the role of the system [703]/market maker is to facilitate lending among borrowers and investors, and that to do this most effectively, the system must facilitate investors to apply their own risk criteria/bias in discriminating among potential borrowers. The system may enable this by allowing investors to create custom loan scorecards to score potential borrowers. As a result, the system may facilitate many niche markets to exist that promote provision of credit to a wider set of potential borrowers. This is particularly true when comparing a P2P lending system to a traditional lending provided by a bank, where there is a single scorecard and single credit policy—which in turn leads to some credit worthy segments of the market being able to obtain limited or no credit as they don't neatly fit the bank's criteria. The system provides Investors with the option to create a customer scorecard [1501], whereby they are able to set their own weighting to scorecard components, set exclusion rules and adjust criteria. As an example, an investor who was concerned about boom/bust economic conditions in areas dominated by the mining industry could set a rule that excluded specific geographic locations. In the same way, an investor could choose to weight borrowers who were graduates of particular universities higher. Another investor might choose to apply a higher weighting to behavioral competencies and less on the bureau score.

The investor's customer scorecard criteria may be stored in system [703] against their investor profile [1503] and used to forecast demand for borrower credit profiles [606]. In step [1504], an underwriting engine may score borrower credit profiles by the investor custom scorecards (in addition the standard system scorecards). Once an investor has set up a custom scorecard, the system may display to them both the standard/system credit scores and customized, loan-qualification scores for borrowers [1505].

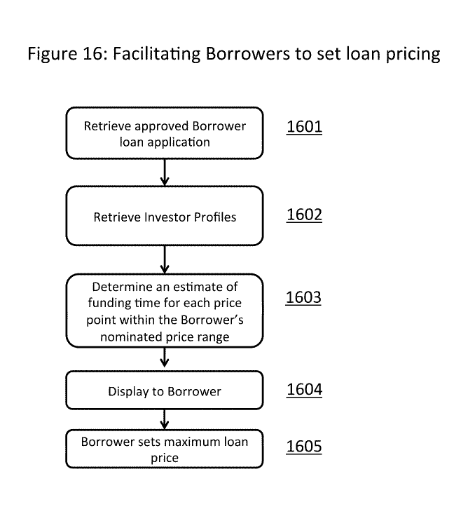

FIG. 16: Facilitating Borrowers to Set Loan Pricing

A key trade-off for borrowers is the interest rate they pay for lending versus the time taken for their loan to be funded by investors. Similarly, investors are seeking to maximize their rate of return on the loans they fund, while keeping their money invested rather than sitting waiting to fund loans. Accordingly, some possible features of a method for facilitating a borrower to set loan pricing through system host [703] include one or more of the following, alone or in various combinations.
In certain embodiments, the system [703] seeks to enable borrowers and investors to trade off interest rates versus time (i.e., funding time) to achieve an optimal market place. To achieve this, borrowers may be provided with information about the availability of funding for their application by interest rate. FIG. 3 shows a screenshot of an example offer presented to a borrower at [210], whereby a borrower can choose to accept an interest rate of 13.5% and receive immediate funding, or they can elect to post their application at lower interest rates with progressively longer funding times (and less certainty of being funded). In this process, the system calculates investor demand for each borrower's loan application and the level of interest rate to provide the estimates of funding time by interest rate.
This process starts by retrieval of both approved borrower loan applications [1601] and investor profiles [1602] from the system.
A matching process determines an estimate of funding time for each price point within the borrower's nominated price range [1603].
This information is presented to the borrower (as per FIG. 3) to enable them to trade-off rate versus funding time in setting their maximum loan pricing (i.e., the maximum interest rate they are prepared to pay for a loan)

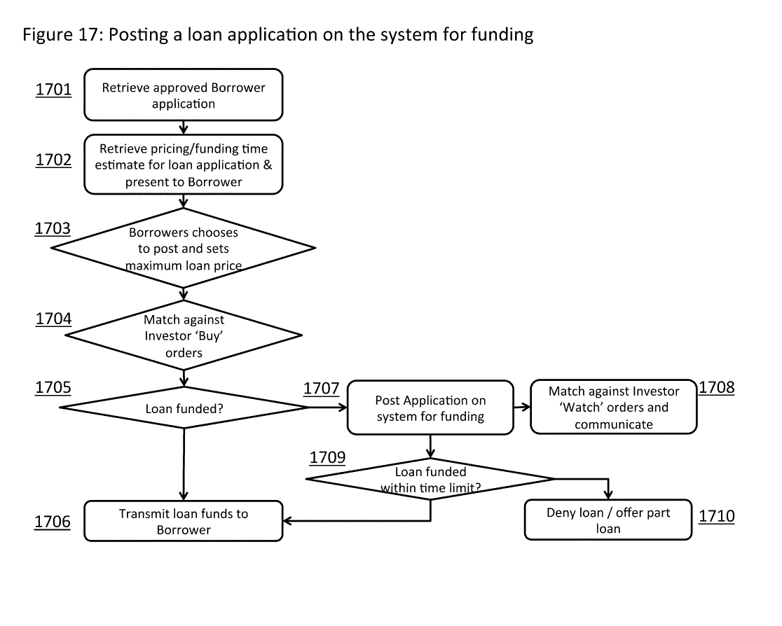

FIG. 17: Posting a Loan Application on the System for Funding

Some possible features of posting a loan application on system [703] for funding include some or all of the steps described in FIG. 17, alone or in various combinations:
Borrowers with approved loan applications choosing to post it on the system for funding set their loan terms and (maximum) interest rate [1701-1703].
The system matches against existing applicable buy bids in the system [1704].
The system posts [1707] remaining units for funding.
Where the loan application meets a watch criteria set up by an investor, the investor is notified [1708].
A maximum time limit is set by the market place for the loan to be funded. If the loan is not fully funded when time limit [1709] is reached, the borrower may elect to take a lower level of funding, or the loan may be denied.
Once loans are deemed to be funded, a loan account is established by the system and is money may be collated from the trust accounts of the lenders and transmitted to the borrower [1705-1706].
If a full funding offer is not achieved, the loan is denied or an offer of a partial loan, or a loan with different terms than specified by the borrower, may be communicated to the borrower [1710].

FIG. 18: Enabling Investors to Set Automatic Funding Instructions

According to certain embodiments of the inventive subject matter, some possible features of a method for enabling investors to set automatic funding instructions through system host [703] include one or more of the following, alone or in various combinations.
In step [1801], investors have the option to choose borrower loan applications manually or automatically. In an automatic setting the investor sets up a “buy” instruction with a maximum funding threshold for a given period of time (e.g., set to automatically fund up to $1000 of loan application (units) within the next 7 days, where the investor purchases up to 1% of any qualifying loan application amount).
In step [1802], as part of setting up the buy instruction on the system, the investor sets up an ordered set of criteria to select and rank loan applications for funding (e.g., 1. loan score >670, 2. loan size $5,000-$10,000, 3. interest rate 12.5%-13.0%). The criteria can include the investor's own customized, loan qualification score as part of the criteria.
In step [1803], the system then ranks loan applications by the investor's criteria and funds loans [1805] up to the value of the set threshold.
In step [1806], if the value of loan applications meeting the criteria exceeds the funding threshold, the remaining (unfunded) loan applications may be placed on a watchlist and tracked for possible funding in the future.
Alternatively an investor can set-up a watchlist instead of a buy instruction.
In step [1807], if the value of loan applications meeting the criteria falls short of the funding threshold, the investor may be advised so that they have the option to adjust their selection criteria.

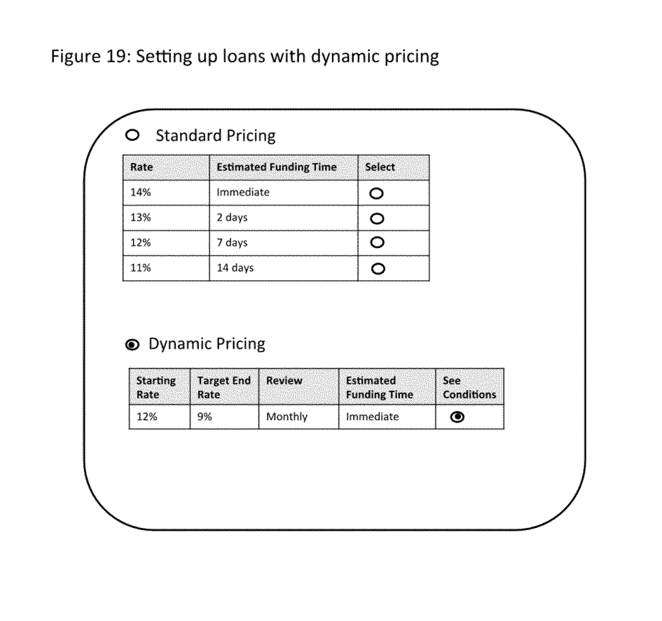

FIG. 19: Setting Up Loans with Dynamic Pricing

A key aspect of the role of the P2P lending site is to facilitate a transparent and efficient loans market place. The process of assessing credit worthiness represents an approximation of default so that lending can be priced to accurately reflect the future returns to an investor net of losses. An alternative approach is the creation of pricing mechanisms that serve in the interests of both investors and borrowers. Some possible features of a method for facilitating the setting up of loans with dynamic pricing through system host [703] include one or more of the following, alone or in various combinations.
borrowers may be enabled to request dynamic pricing whereby their interest rate is continually, or at predetermined times or events, adjusted in-line with their current or trending loan qualification score (calculated as per FIG. 14, for example).
In FIG. 19, the borrower may be given the option to choose between standard pricing or dynamic pricing, when they choose to post their loan application for funding.
A dynamic pricing offer may include a starting rate of interest and a target end rate of interest. These interest-rate figures may be determined by the system based on the current loan qualification score of the borrower and a forecast future loan qualification score at the end of the loan. The calculation of the forecast future loan qualification score may include the use of the borrower's behavior based competency scores and benchmarking of loan qualification score movements by like profiles.
A dynamic pricing offer may include a set of terms and conditions (as per FIG. 5) that provides a guide of loan qualification score movements for a range of repayment behaviors.
In practice, the borrower is able to achieve the target end interest rate by ensuring their repayment behavior is within the conditions outlined.
Conversely, if the borrower's loan qualification score deteriorates, their interest rate may increase under this model for dynamic pricing.

FIG. 3 is an example of a graphical user interface for a borrower's computer system, in this case a screen for a mobile device. The screen notifies the borrower of qualification for a loan and various loan related details, including a loan qualification score, details of loan options being offered, and input options.

FIG. 5 shows details for dynamic loan pricing based on varying loan qualification scores and possible penalty terms.

FIG. 20: Description of the Development of Behavior Based Competency Scores

Exemplary guiding principles are (1) that people's behaviors relative to their peers within the same life-stage range are largely constant over time; (2) that people's behavioral characteristics can be measured by data that can be sourced from third-party sources sufficiently to rank order people against their life-stage peers; and (3) that specific behavioral characteristics can be correlated to creditworthiness. As a consequence, it is possible to rank order peers (within the same life-stage group) according to specific behavioral characteristics (and without replying on credit history) as a means of identifying which customers are most likely to default on a loan [2002]. This overcomes the limitations of existing credit scoring models that are heavily reliant on previous credit history as the dominant predictive factor of future creditworthiness, which only become reliable once the borrowers being scored have sufficient credit history for the model to discriminate [2001].

Some possible features of a method for facilitating development of behavior based competency scores through system host [703] include one or more of the following, alone or in various combinations.
Behavioral data is extracted by system [703] from third-party sources for a large sample of people.
Data across the different data sources is collated by each individual in the sample and prepared for scoring.
Each person is scored based on their behaviors across a plurality of categories, such as some or all of the following five categories: Financial Management, Leadership, Networking, Advocacy, and Accountability.
People may be grouped by their life-stage, and scores are calibrated within each group to identify appropriate cut-off scores that distribute customers according to their level for each competency (i.e., enabling people to be scored as having a superior level of competency through to inferior level of competency, relative to their life-stage peers).
People may then be rank ordered amongst their peers by each behavioural competency and the relative scores used to calculate a probabilistic likelihood that they will default on a loan.
As an example, an algorithm that enables borrowers to be scored for credit worthiness based on behavioral competency scores might be developed and implemented as follows:
   (1) People in the sample are broken into life-stage groups based on age brackets. A starting life-stage group is selected as the first group to be modeled based on availability of credit history (i.e., an older group).
   (2) Each member of the group is ranked in order according to credit history performance.
   (3) Each member of the group is also ranked in order according to each behavioral attribute.
   (4) A statistical model calculates the relationship between the rank order position on each behavioral attribute and overall rank order position of credit performance to producing a scoring algorithm.
   (5) The scoring algorithm is applied on the remaining life-stage groups as a means of rank ordering people relative to their life-stage peers on their likely credit performance. The scoring algorithm is optimized for each life-stage group and probabilities of default for each person in the group can be assigned based on (a) their rank-order position in the group and (b) a scaling factor aligned to the historic default rate of the life-stage group.
   As an example of the algorithm, it may be established that networking behaviors, as defined by the number of executive level LinkedIn connections a person has, is highly correlated to credit performance. For a person aged 45-55, a high score (that indicates low credit risk) relative to their peers might be 100 executive level connections. For a person aged 25-35, an equivalent high score relative to peers might be 25 executive level connections. Based on this behavioral attribute alone, both people would have similar ranking relative to their peers and be judged to be of similar credit quality. Their final loan qualification scores would also be similar, although scaled by the inherent default rate of their respective life-stage groups.

### Computing Environments

FIG. 21 illustrates a generalized example of a suitable computing environment 1100 in which described methods, embodiments, techniques, and technologies may be implemented. The computing environment 1100 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 21, the computing environment 1100 includes at least one central processing unit 1110 and memory 1120. In FIG. 8, this most basic configuration 1130 is included within a dashed line. The central processing unit 1110 executes computer-executable instructions and may be a real or a virtual processor. In a multi-processing system, multiple processing units execute computer-executable instructions to increase processing power and as such, multiple processors can be running simultaneously. The memory 1120 may be volatile memory (e.g., registers, cache, RAM), non-volatile memory (e.g., ROM, EEPROM, flash memory, etc.), or some combination of the two. The memory 1120 stores software or other instructions 1180 that can, for example, implement one or more of the innovative technologies described herein. A computing environment may have additional features. For example, the computing environment 1100 includes storage 1140, one or more input devices 1150, one or more output devices 1160, and one or more communication connections 1170. An interconnection mechanism (not shown) such as a bus, a controller, or a network, interconnects the components of the computing environment 1100. Typically, operating system software (not shown) provides an operating environment for other software executing in the computing environment 1100, and coordinates activities of the components of the computing environment 1100.

The physical storage 1140 may be volatile or non-volatile removable or non-removable, and includes magnetic disks, magnetic tapes or cassettes, CD-ROMs, CD-RWs, DVDs, solid-state memory devices, or any other physical medium which can be used to store information and which can be accessed within the computing environment 1100. The storage 1140 stores instructions for the software or other instructions 1180, which can implement technologies described herein. It also may be used to store data related to instructions and to the methods disclosed herein. As persons skilled in the art will appreciate, any stored data may be stored into the physical storage devices so as to be physically embodied into such devices as organized or defined data structures or data footprints (such data structures or footprints may hereinafter referred to as a “stored data configuration”).

The input device(s) 1150 may be a touch input device, such as a keyboard, keypad, mouse, pen, or trackball, a voice input device, a scanning device, or another device, that provides input to the computing environment 1100. For audio, the input device(s) 1150 may be a sound card or similar device that accepts audio input in analog or digital form, or a CD-ROM reader that provides audio samples to the computing environment 1100. The output device(s) 1160 may be a display, printer, speaker, CD-writer, or another device that provides output from the computing environment 1100.

The communication connection(s) 1170 enable communication over a communication medium (e.g., a connecting network) to another computing entity. The communication medium conveys information such as computer-executable instructions, compressed graphics information, or other data. The information can pertain to a physical parameter observed by a sensor or pertaining to a command issued by a controller, e.g., to invoke a change in an operation of a component in any of the systems disclosed herein.

Computer-readable media are any available physical media that can be accessed within a computing environment 1100. By way of example, and not limitation, with the computing environment 1100, computer-readable media include memory 1120, storage 1140, communication media (not shown), and combinations of any of the above.

The examples described herein generally concern improved lending systems. Other embodiments than those described above in detail are contemplated based on the principles disclosed herein, together with any attendant changes in configurations of the respective apparatus and changes in logic flow described herein. Incorporating the principles disclosed herein, it is possible to provide a wide variety of improved lending systems.

As used herein, “and/or” means “and” or “or”, as well as “and” and “or.” Moreover, any and all patent and non-patent literature cited herein is hereby incorporated by references in its entirety for all purposes.

The principles described above in connection with any particular example can be combined with the principles described in connection with any one or more of the other examples. Accordingly, this detailed description shall not be construed in a limiting sense, and following a review of this disclosure, those of ordinary skill in the art will appreciate the wide variety of lending systems and other systems that can be devised using the various concepts described herein. Moreover, those of ordinary skill in the art will appreciate that the exemplary embodiments disclosed herein can be adapted to various configurations without departing from the disclosed principles.

The previous description of the disclosed embodiments is provided to enable any person skilled in the art to make or use the disclosed innovations. Various modifications to those embodiments will be readily apparent to those skilled in the art, and the generic principles defined herein may be applied to other embodiments without departing from the spirit or scope of this disclosure. Thus, the claimed inventions are not intended to be limited to the embodiments shown herein, but are to be accorded the full scope consistent with the language of the claims, wherein reference to an element in the singular, such as by use of the article “a” or “an” is not intended to mean “one and only one” unless specifically so stated, but rather “one or more”.

All structural and functional equivalents to the elements of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed as “a means plus function” claim under US patent law, unless the element is expressly recited using the phrase “means for” or “step for”.

The inventors reserve all rights to the subject matter disclosed herein, including the right to claim all that comes within the scope and spirit of the following claims:

1. A computer system configured with a set of stored instructions for:
a. communicating over a computer network with a plurality of third-party databases, each storing data relevant to a specified borrower's qualification for a loan or qualification for changing terms of an existing loan;
b. retrieving the relevant data from a plurality of the third party databases;
c. automatically processing the data into a loan application, a borrower credit profile and/or a loan qualification score for a loan, and
d. creating in a physical storage component associated with the system one or more stored data configurations corresponding to the loan application, borrower credit profile, and/or loan qualification score.

2. The computer system of claim 1 wherein the loan application, borrower credit profile and/or a loan qualification score for a loan is provided or otherwise made accessible via a computer network to an investor.

3. The computer system of claim 2 wherein the computer system communicates third-party computer systems to retrieve data relevant to assessing borrowers' behavioral-based competencies, the data not directly representing financial data and credit history data of the borrowers.

4. The computer system of claim 3 wherein the third-party computer systems comprise computer systems of social networking sites.

5. The computer system of claim 2 wherein the system is configured to provide or make accessible to an investor periodic updates on an existing borrower's qualification for a loan program.

6. The computer system of claim 5 wherein system is configured to change the terms of an existing borrower's loan during the term of the loan based on an update, wherein the change in terms include a change in interest rate, loan term, loan amount, and/or monthly payment.

7. The computer system of claim 2 wherein the system is configured with instructions that allow for a loan qualification scorecard to be customized according to the specification of a particular investor.

8. The computer system of claim 1 wherein the system is configured to allow a borrower to opt in or out of publishing the borrower's qualification for a loan to a potential investor(s).

9. The computer system of claim 2 wherein the system is configured for automatically storing and updating the loan application, credit profile, and/or loan qualification score for each of a plurality of borrowers.

10. The computer system of claim 9 wherein the system automatically provides or otherwise makes available to different investors the loan application, credit profile or loan qualification score or rating for a borrower.

11. The computer system of claim 9 wherein the system provides or otherwise makes available to different investors the loan application, credit profile, or loan qualification score for each of a plurality of borrowers.

12. The computer system of claim 1 wherein the system is configured to calculate investor demand by the categorizing borrower credit profiles and/or loan qualification scores and to calculate optimal pricing based on supply and demand for predetermined categories.

13. A method of dynamic loan pricing performed over a computer system, comprising:
at predetermined intervals, updating an existing borrower's loan application, credit profile, or loan qualification score;
changing the terms of an existing borrower's loan during the term of the loan, or making a new loan offering, based on an update, wherein the change in terms include a change in interest rate, loan term, loan amount, and/or monthly payment; and
creating in a physical storage component associated with a computer system one or more stored data configurations corresponding to the loan application, borrower credit profile, loan qualification score and/or the change in loan terms.

14. The method of claim 13 wherein the monitoring is performed on a central computer system in communication with an investor computer system, and the monitoring is performed on the central computer system and communicated to the investor computer system, which updates a stored account for a borrower and stores a change in loan terms and automatically adjusts a borrower's electronic account information in accordance with the change in terms.

15. A method of lending executed over a computer system, the method comprising the steps of:
storing on a central computer system data configurations representing a plurality of existing borrower credit profiles, the profiles comprising at least (i) a desired loan amount or other loan term and (ii) a loan qualification score, wherein each score is based on third-party data that is relevant to three or more of the following loan qualification assessment factors: financial management, leadership, social networking, advocacy, and accountability;
communicating over a computer network the one or more of the borrower profiles to investor computer systems;
receiving on the central computer system, in response to the provision of borrower credit profiles, a loan funding offer responsive to one or more of the borrower credit profiles; and
creating in a physical storage component associated with the system one or more stored data configurations corresponding to the loan funding offers.

16. The method of claim 15 wherein the loan funding offer is communicated via the central computer system to a borrower associated with a borrower credit profile.

17. The method of claim 14 wherein a loan funding offer is based on a plurality of investors collectively agreeing to fund a loan related to one or more borrower credit profiles.

18. A computer system configured for creating a composite loan from fractional loan units (subunits) funded by different investors, the system including a set of stored instructions for:
a. communicating over a computer network to a plurality of computer systems for different investors one or more offers for funding a subunit of a composite loan for a borrower;
b. receiving from one or more investors over a computer network a response to the one or more offers indicating willingness to fund a loan subunit; and
c. creating in a physical storage component associated with the system one or more stored data configurations corresponding to a composite loan based on the responses from the investors.

19. The computer system of claim 19 wherein the offers or the responses to the offers correspond to a plurality of loan subunits having different rates, the composite loan having a rate that is blended according to the rates of the subunits.

20. The computer system of claim 19 wherein the system is configured to establish a blended rate that does not exceed a maximum rate.

21. The computer system of claim 20 wherein the system is configured to allow a borrower to set the maximum rate.

22. The computer system of claim 19 wherein the offers are provided via an auction process.

23. The computer system of claim 22 wherein an investor's indicating willingness to fund a loan subunit comprises making a bid for a subunit.

24. A method for creating a composite loan from fractional loan units (subunits) funded by different investors, the method comprising the steps of:
a. communicating over a computer network to a plurality of computer systems for different investors one or more offers for funding a subunit of a composite loan for a borrower;
b. receiving from one or more investors over a computer network a response to the one or more offers indicating willingness to fund a loan subunit; and
c. creating in a physical storage component associated with the system one or more stored data configurations corresponding to a composite loan based on the responses from the investors.

25. The method of claim 24 wherein the offers or the responses to the offers correspond to a plurality of loan subunits having different rates, the composite loan having a rate that is blended according to the rates of the subunits.

26. The method of claim 25 wherein the system is configured to establish a blended rate that does not exceed a maximum rate.

27. The computer system of claim 26 wherein the system is configured to allow a borrower to set the maximum rate.

28. The computer system of claim 24 wherein the offers are provided via an auction process.

29. The computer system of claim 28 wherein an investor's indicating willingness to fund a loan subunit comprises making a bid for a subunit.

30. A computer system configured to coordinate the supply and demand for credit within a marketplace, the system including stored instructions for:
a. automatically monitoring loan supply and demand parameters across a plurality of borrowers and a plurality of investors based on based on a plurality of borrower credit profiles and investor profiles stored on a computer system;
b. communicating over a computer network to a plurality of computer systems for different investors and/or borrowers an offer based on changes in loan supply and demand;
c. receiving from one or more borrowers and/or investors over a computer network a response to the one or more offers; and
d. creating in a physical storage component associated with the system one or more updated borrower or investor profiles corresponding to a response on the responses from a borrower and/or an investor.

31. The system of claim 30 wherein the borrower profiles comprise at least (i) a desired loan amount or other loan term and (ii) a loan qualification score, wherein each score is based on third-party data that is relevant to two or more of the following loan qualification assessment factors: financial management, leadership, social networking, advocacy, and accountability.

32. A method to coordinate the supply and demand for credit within a marketplace, the method comprising the steps of:
a. automatically monitoring loan supply and demand parameters across a plurality of borrowers and a plurality of investors based on based on a plurality of borrower credit profiles and investor profiles stored on a computer system;
b. communicating over a computer network to a plurality of computer systems for different investors and/or borrowers an offer based on changes in loan supply and demand;
c. receiving from one or more borrowers and/or investors over a computer network a response to the one or more offers; and
d. creating in a physical storage component associated with the system one or more updated borrower credit profiles or investor profiles corresponding to a response on the responses from a borrower and/or an investor.

33. The method of claim 32 wherein the borrower credit profiles comprise at least (i) a desired loan amount or other loan term and (ii) a loan qualification score, wherein each score is based on third-party data that is relevant to two or more of the following loan qualification assessment factors: financial management, leadership, social networking, advocacy, and accountability.

34. A method of lending, comprising:
communicating to a computer system of a borrower computer executable instructions for:
an interactive, graphical user interface enabling the borrower to input a loan amount or program desired and personal data enabling the creation of a borrower credit profile based on one or more of the following loan qualification assessment factors: financial management, leadership, social networking, advocacy, and accountability data relevant to assessing borrowers' behavioral-based competencies, the loan assessment factors not directly representing financial data and credit history data of the borrowers; and
enabling the user to communicate the personal data to a central computer system, over a data network storing a plurality of different borrower profiles based or derived from personal data input from borrowers and stored on the central computer system.

35. The method of claim 34 wherein the personal data comprises an input of data that enable the central computer system to automatically access third-party computer systems over a data network and automatically retrieve data comprising loan qualification assessment data from the third-party system.

36. The method of claim 34 further comprising providing an investor with or more of the stored borrower profiles.

37. The method of claim 36 wherein a borrower profile comprises a loan qualification score derived at least in part from the personal data.

38. The method of claim 34 further comprising providing a plurality of different investors one or more offers for funding a subunit of a composite loan for a borrower based on at least the input of the loan amount or program desired by a borrower.

39. The method of claim 34 further comprising providing an investor with an updated borrower profile for a borrower during the term of an existing loan funded by the investor.

40. The method of claim 34 further comprising providing the borrower with updated loan terms following a change of borrower's credit profile during the term of an existing loan.
